(19) United States
(12) Patent Application Publication
(10) Pub. No.: US 2013/0198676 A1
(43) Pub. Date: Aug. 1, 2013

(54) METHOD AND SYSTEM FOR INTERACTIVE COMPUTER-IMPLEMENTED PROJECT MANAGEMENT

(71) Applicant: DENTAL EQUIPMENT, LLC, Charlotte, NC (US)

(72) Inventors: Matthew Garrett, Waxhaw, NC (US); Kirk Zambetti, Charlotte, NC (US); Marc Stollings, Georgetown, KY (US); Chris Garris, Lancaster, SC (US); Jessica O'Rourke, Rock Hill, SC (US); Krista Bokhari, Charlotte, NC (US); Christina Cooley Nunez, Charlotte, NC (US)

(73) Assignee: DENTAL EQUIPMENT, LLC, Charlotte, NC (US)

(21) Appl. No.: 13/723,256

(22) Filed: Dec. 21, 2012

Related U.S. Application Data
(60) Provisional application No. 61/579,034, filed on Dec. 22, 2011.

(51) Int. Cl. G06F 3/0484

(52) U.S. Cl. CPC G06F 3/0484
USPC 715/772

(57) ABSTRACT

A computer-implemented method, system, and computer readable medium for managing a project is provided in the form of a project management tool for designing a medical practice, wherein the tool is adapted guide a user through at least partial or a predetermined amount of completion of a design project through a series of phases, each phase comprising one or more predetermined action items for the design project, wherein the project management tool, when executed by a processor, generates a graphical user interface adapted to allow progression through each phase in the series of phases.

This application claims priority from U.S. provisional application Ser. No. 61/579,034, filed Dec. 22, 2011, the disclosure of which is incorporated herein by reference in its entirety.

### COPYRIGHT NOTICE

A portion of the disclosure of this patent document, including Figures, contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

This invention relates to a method and system for interactive computer-implemented project management, and specifically to an improved system, method, and computer-readable instructions for interactive computer-implemented process and project management for planning and implementing a dental practice.

For years, dentists have struggled to successfully manage the complexities associated with new dental office projects or major modernizations. Dentists are clinicians by trade and often lack the business management, financial and project management experiences required to successfully complete such a complex transaction. Many dentists are realizing that the conventional design process is not satisfactory to meet their needs. As such, dentists typically would aggregate tools and resources from various sources including consultants, text books, seminars, dealers and manufacturers, but no consolidated process has been available. Thus, dentists typically delay such investments or awkwardly proceed with enhanced levels of risk.

Therefore, there is a need in the art for a method and a system for an improved system, method, and computer-readable instructions for interactive computer-implemented process and project management for planning and implementing a dental practice.

### SUMMARY OF THE INVENTION

The present invention solves the above-stated problems in the art by providing an interactive computer-implemented process and project-management system and method that incorporates a series of input tools that systematically process and ultimately report to the user critical information necessary to bring a medical practice, such as a dental practice, to a reality.

The project-management system and method preferably includes a web-based Graphical User Interface (GUI) including an input component and a display component, preferably implemented as a web portal; wherein the input component receives project inputs and outputs results after analysis and computations are implemented. The process incorporates six phases: Discovery, Enlighten, Envision, Create, Realize and Reflect. A series of tools and resources are provided that systematically take the user through the design process, preferably dental office design. Tools are provided that range from highlighting financial viability, production targets, project management requirements, after sale satisfaction elements, and marketing tools. The method may additionally include generating a report for the project-management. The method can also include displaying the report in the web-based GUI/portal.

An embodiment is implemented as a web portal that houses the series of six phases. Each phase contains unique tools that gather information/input from the user, calculate and ultimately analyze and output/report facts to the user. Using the online interactive web portal, the user signs in and is brought to a personalized project management dashboard. The user will check off completed tasks that are required to move their project build/remodel or renovation (e.g., dental office design) closer to completion.

One such task is the financial analysis, where the user is asked to input numbers regarding their desired dental practice, including size requirements, tax bracket, equipment desired, capital and non-capital costs, operating costs, debt service, patient fees, patient visits, and collections. The outputs include a Space Plan, Equipment Plan, Financial Plan, Production Plan and Tax Plan that outline the financial ramifications (either positive or negative) of proceeding with the new project.

A preferred embodiment of the method is comprised of the following steps: User accesses the web portal for project management. User registers for an account. The system creates a personalized project management account for the user. The user invites applicable parties (including equipment coordinators, contractors, design experts, etc.) to access the portal by adding them to their account. The process takes the user through 6 stages of the project management: Discovery, Enlighten, Envision, Create, Realize and Reflect. The user begins in phase 1, completing various tasks and marking them as complete. The system tallies the progress of the project in a numerical progress calculation based on the total number of steps within that phase. When a user has completed all steps in phase 1, the system pushes the project to phase 2. This process continues through phase 6, which culminates in the completion of the dental office design project.

Features of the invention can be implemented in numerous ways, including as a system, a method, a computer site/portal, or a non-transitory computer readable medium. The invention preferably relies on a communications infrastructure, for example the Internet, wherein individual interaction is possible. Several embodiments of the invention are discussed below.

As a method, an embodiment of the invention generally comprises (a) providing a project management tool for designing a medical practice, wherein the tool is adapted to guide a user through at least partial completion of a design project through a series of phases, each phase comprising one or more predetermined action items for the design project, wherein the project management tool, when executed by a processor, generates a graphical user interface adapted to allow progression through each phase in the series of phases by: (i) displaying a current phase and the one or more action items to be completed for the current phase; (ii) receiving input from the user for each of the one or more action items; (iii) monitoring completion of each of the one or more action items; (iv) upon completion of the one or more action items in the current phase, proceeding to a next phase in the series of phases; (b) calculating from the input received design data for the design project; (c) outputting a report comprising the calculated design data for the design project.

As a computer system, part of the invention generally includes a database and a processor unit. The processor unit operates to receive information for the project management and to analyze the received information. As the project progresses, the system generates outputs. The outputs may include print or electronic media. Part or all of the data can also be sent electronically and maintained on a web server for confidential access with typical browsers. The data may also be transmitted and viewed by other well known techniques such as email, interactive television, and the like. The computer site is preferably viewed with a client web browser as an HTML document through a web secure server communicating with an application server having a database associated therewith. In an embodiment, the invention comprises a project management system for designing a medical practice, including: a processor, and memory coupled to the processor, wherein the memory comprises program instructions executable by the processor to implement a project management tool stored in memory, wherein the tool is adapted to guide a user through at least partial completion of a design project through a series of phases, each phase comprising one or more predetermined action items for the design project, wherein the project management tool, when executed by the processor, generates on a display a graphical user interface adapted to allow progression through each phase in the series of phases by: (i) displaying a current phase and the one or more action items to be completed for the current phase; (ii) receiving input from the user for each of the one or more action items; (iii) monitoring completion of each of the one or more action items; (iv) upon completion of the one or more action items in the current phase, proceeding to a next phase in the series of phases; wherein the processor is adapted to calculate from the input received design data for the design project and output a report comprising the calculated design data for the design project.

As a non-transitory computer readable medium containing program instructions for collecting, analyzing and generating output, an embodiment of the invention includes computer readable code devices for interacting with a user as noted above, processing that data, and generating printed or electronic media for that user. In an embodiment, a non-transitory computer-readable medium having stored thereon code devices for implementing a computer-implemented project management method, the code devices comprising a project management tool for designing a medical practice, wherein the tool is adapted to guide a user through at least partial completion of a design project through a series of phases, each phase comprising one or more predetermined action items for the design project, wherein the project management tool, when executed by a processor, generates a graphical user interface adapted to allow progression through each phase in the series of phases by: (i) displaying a current phase and the one or more action items to be completed for the current phase; (ii) receiving input from the user for each of the one or more action items; (iii) monitoring completion of each of the one or more action items; (iv) upon completion of the one or more action items in the current phase, proceeding to a next phase in the series of phases; and wherein the project management tool is adapted to calculate from the input received design data for the design project and output a report comprising the calculated design data for the design project.

Accordingly, an aspect of the invention includes providing a method and a system for a process and project management computer system. A further aspect of the invention is to provide the maximum of information to a user of the process and project management computer system. Other aspects and features can include, for example, the project management tool being implemented on a server computer as an interactive web portal accessible to a remote client computer via a communications network; providing third-party access to the project management tool upon receiving input by the user that authorizes third-party access; automated or user generated updating of a status indicator to acknowledge completion of each of the one or more action items; displaying a completion progress indicator that indicates a percent completion of all phases and of the current phase; calculating design data for the design project comprises analyzing the design data in conjunction with predetermined design and project management protocols; monitoring a predetermined schedule for the design project and providing a status indicator message regarding whether the design project is on schedule or behind schedule; transmitting the report comprising the calculated design data for the design project to third parties to assist in the coordination and implementation of the design project.

Other aspects and advantages of the invention will become apparent from the following detailed description taken in conjunction with the accompanying drawings, illustrating by way of example the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification. The following patents and published applications are incorporated by reference: U.S. Pat. Nos. 6,023,702, 7,962,358, 2008/0288322.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1A shows an illustrative computer network for implementing the system and method.

FIG. 2A shows an example computer for implementing the system and method.

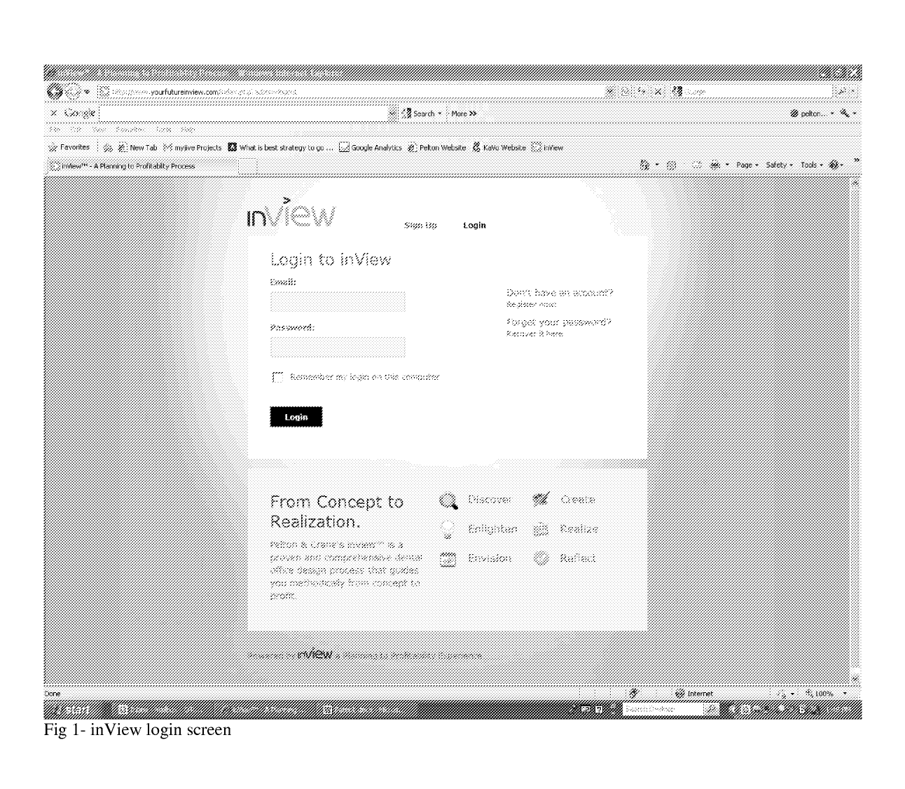

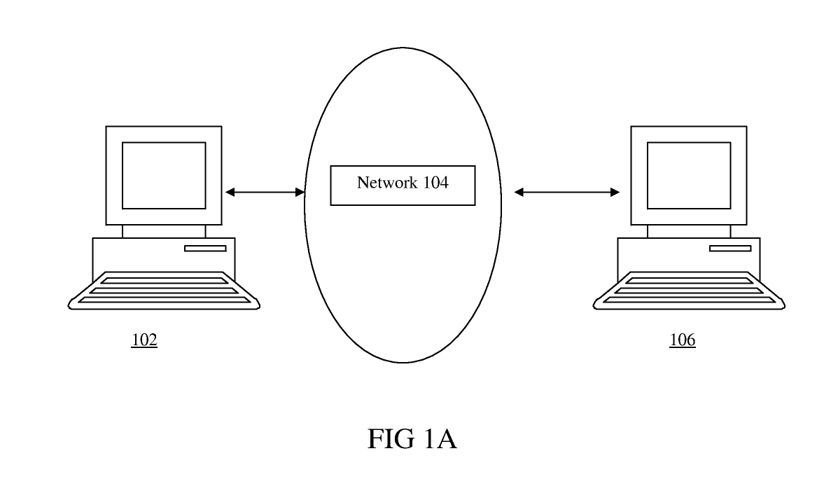

FIGS. 1-35 are example screen shots of an embodiment of the project management system.

It should be understood that in certain situations for reasons of computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawing, these details are not intended to limit the scope of the invention.

### DETAILED DESCRIPTION OF THE PREFERRED EMBODIMENTS

Reference will now be made in detail to the embodiments consistent with the invention, examples of which are illustrated in the accompanying drawings. Wherever possible, the same reference numerals used throughout the drawings refer to the same or like parts.

The present invention solves the problems in the art by providing a system and method for an interactive computer-implemented process and project-management system and method that incorporates a series of input tools that systematically process and ultimately report to the user critical information necessary to bring a medical practice, such as a dental practice, to a reality. Preferably, the invention is operated in conjunction with an interactive web site, referred to herein as a portal.

The concept of a “project” in general is concerned with placing activities on a time line, often defined by a calendar. Each activity is planned to have a time duration and has to be executed by a resource, e.g. a person or a member of a team of persons. Project management is concerned with the achievement of target dates while using available resources, staying within the sequencing constraints of activities. An example of a project used herein is the design of a dental practice.

The present invention generally comprises a client web interface (CWI) application for graphical user interface (GUI), maintenance (back-end) applications to support the site, database server software and the database associated therewith, and an administrative interface, each of which will be discussed in detail below.

FIG. 1A is a high level diagram of an exemplary computing system network on which the present invention may be implemented. The system includes a web server 102 for storing web pages, and a client computer 106 capable of accessing the web pages on server 102. Server 102 may be any number of known computers, or network of computers, capable of hosting a website. Similarly, client 106 may be any number of known computers, or network of computers, capable of supporting a web browser. Server 102 and client 106 are coupled to one another via a network 104, such as the Internet. To retrieve a web page stored on server 102, the user of client 106 specifies a URL (uniform resource locator). The specified URL allows web browsing software running on client 106 to initiate communication with server 102 and access the desired HTML page, which a browser interprets and displays on client 106.

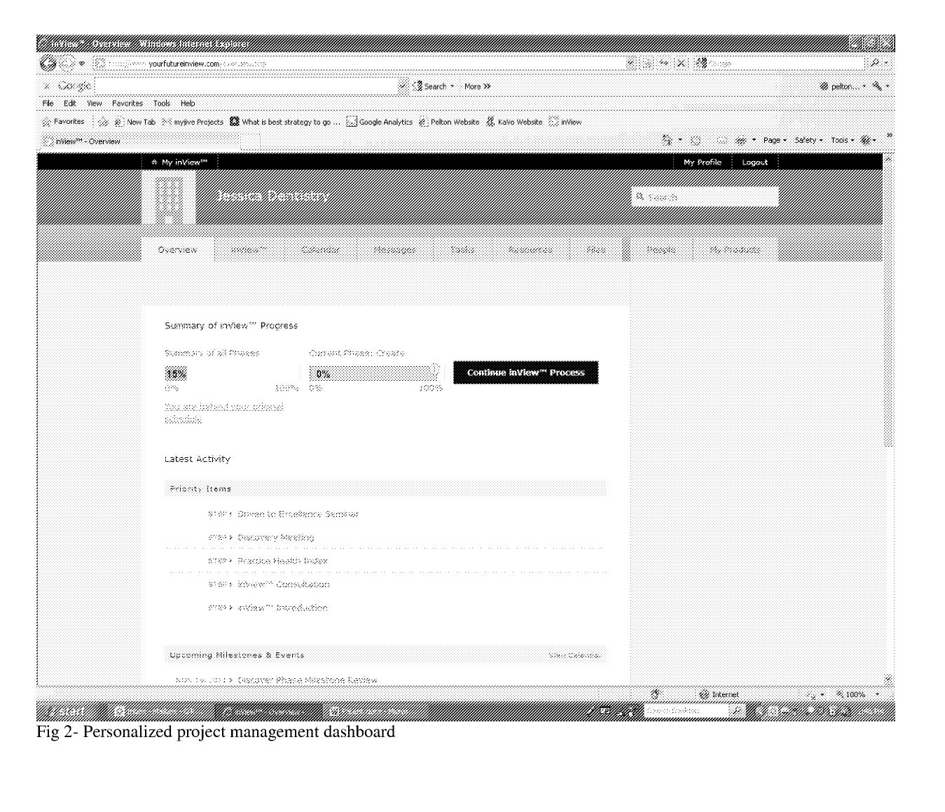

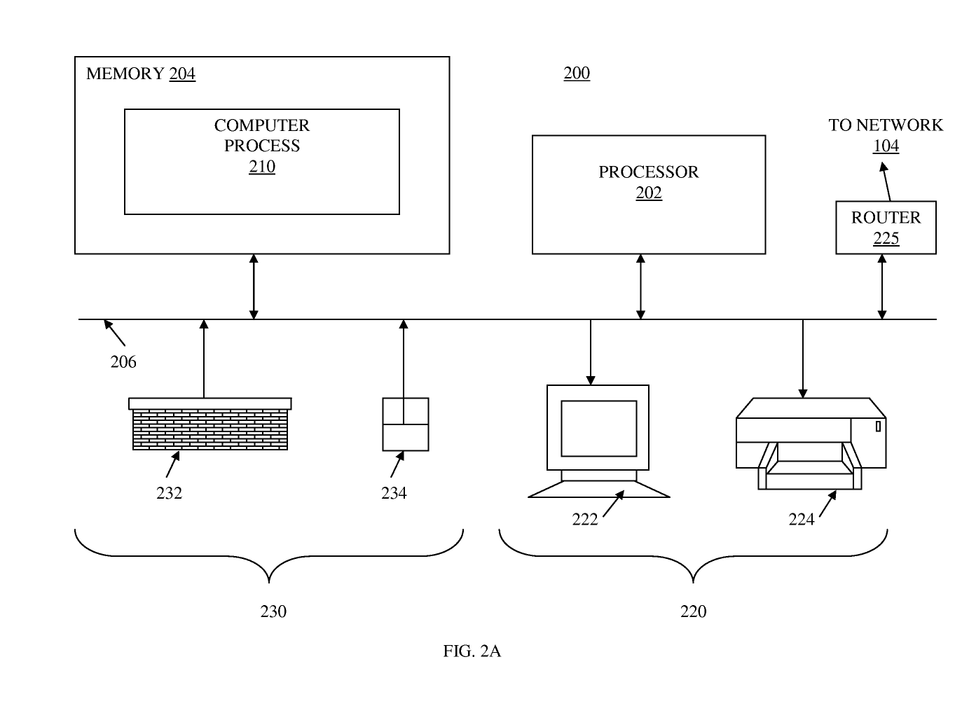

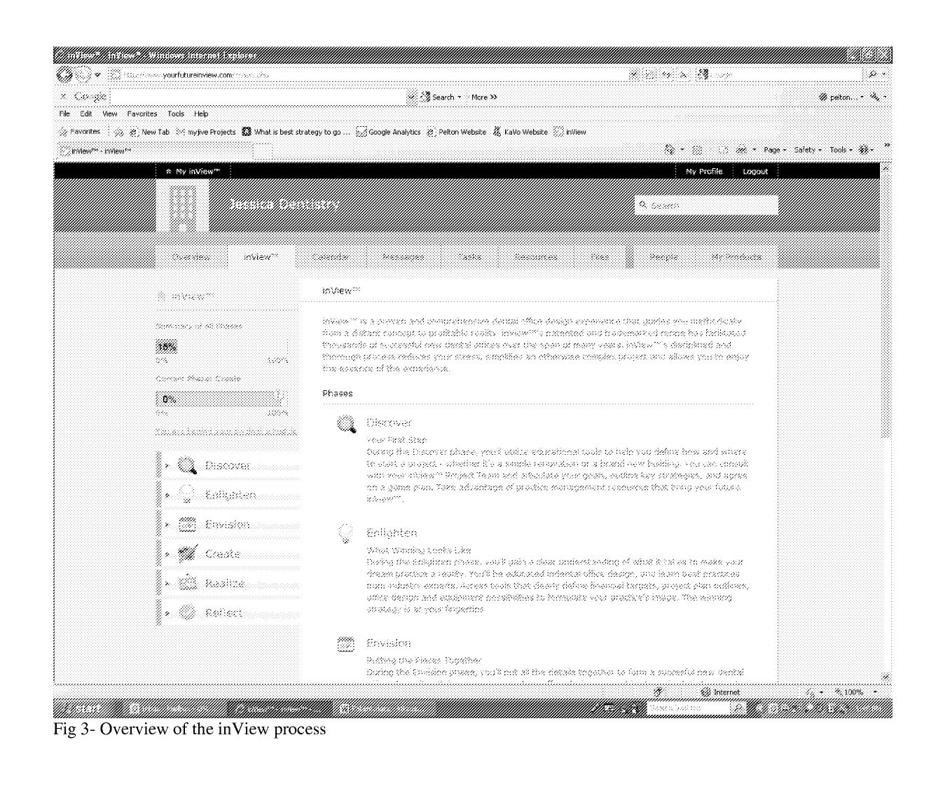

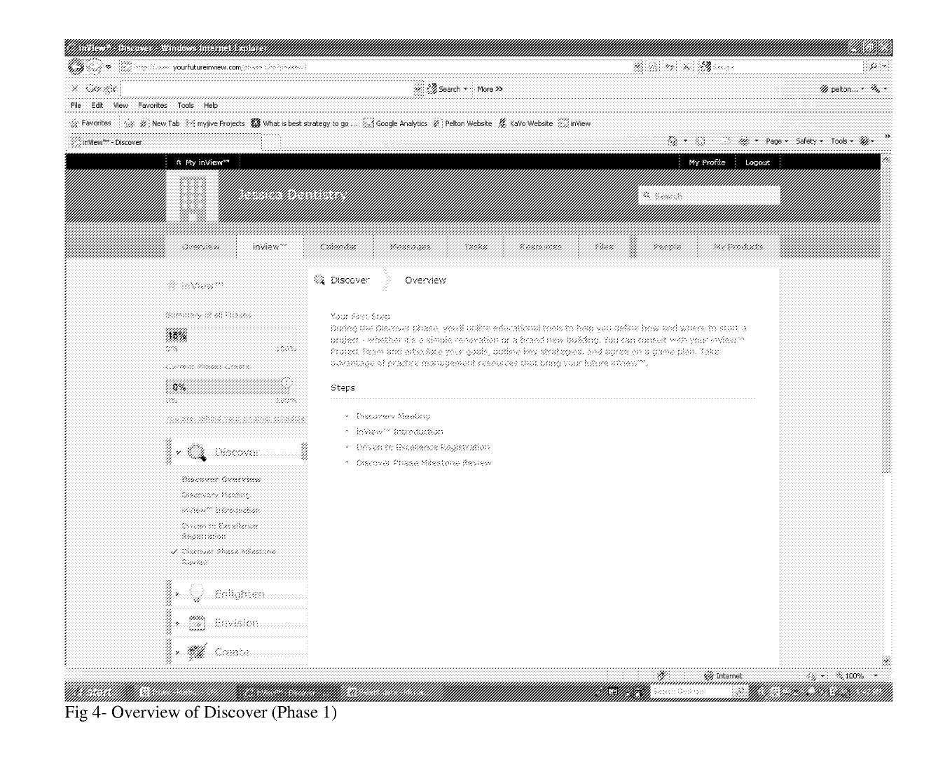

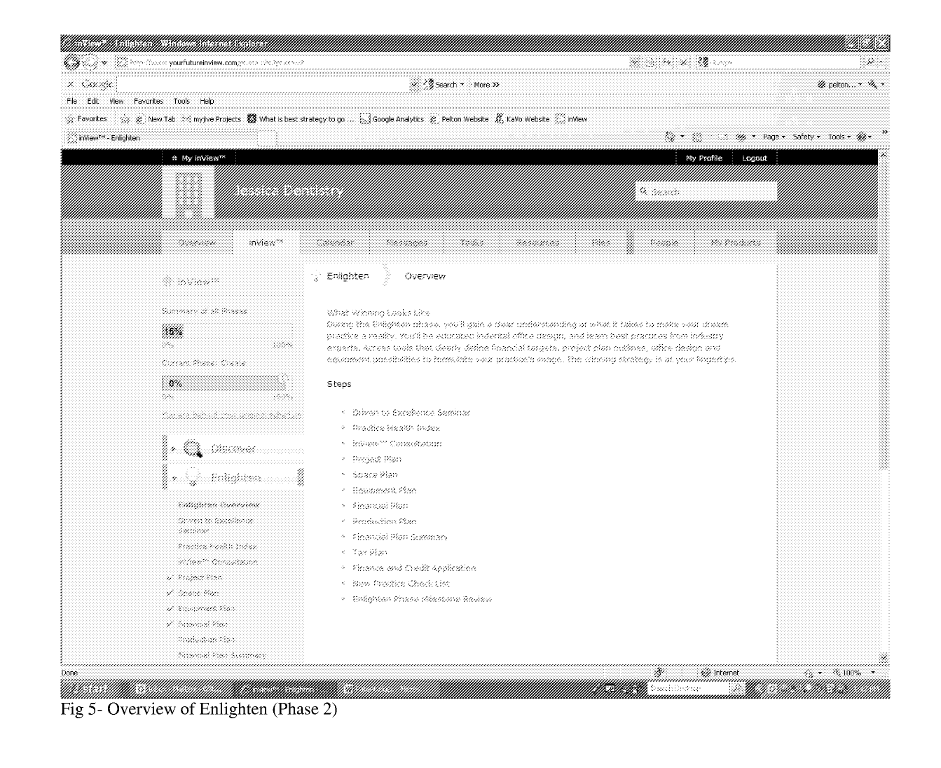

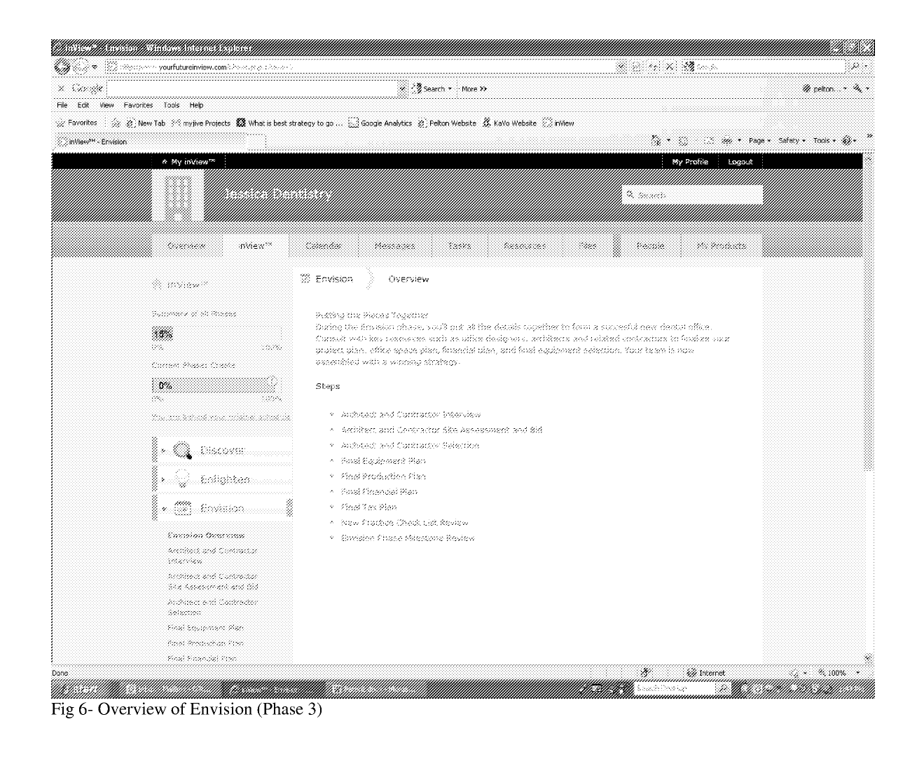

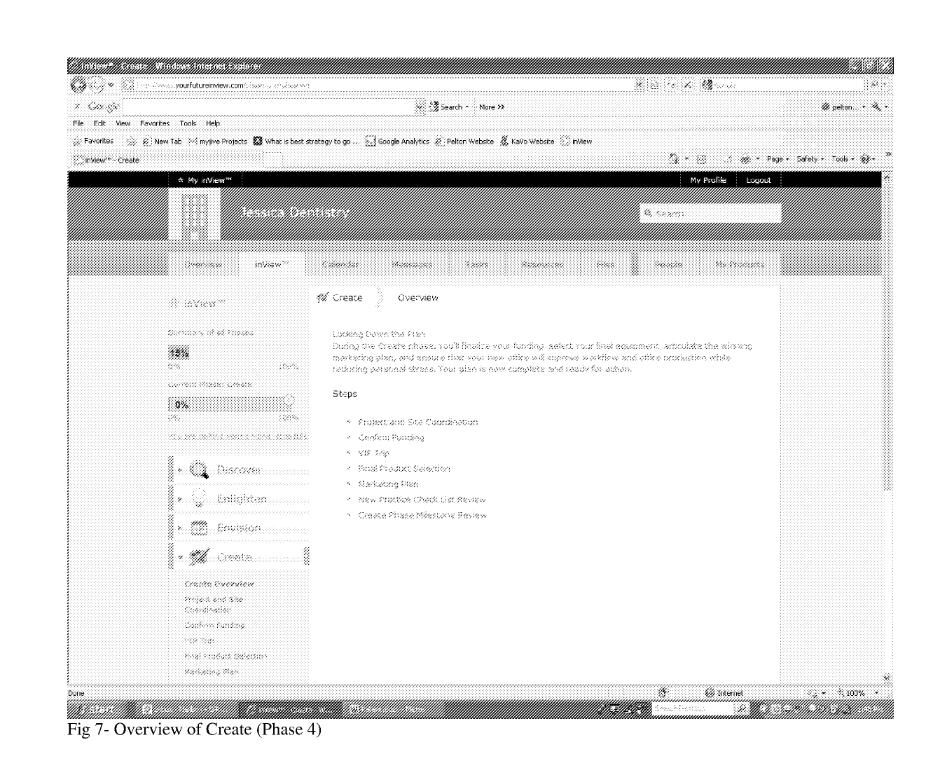

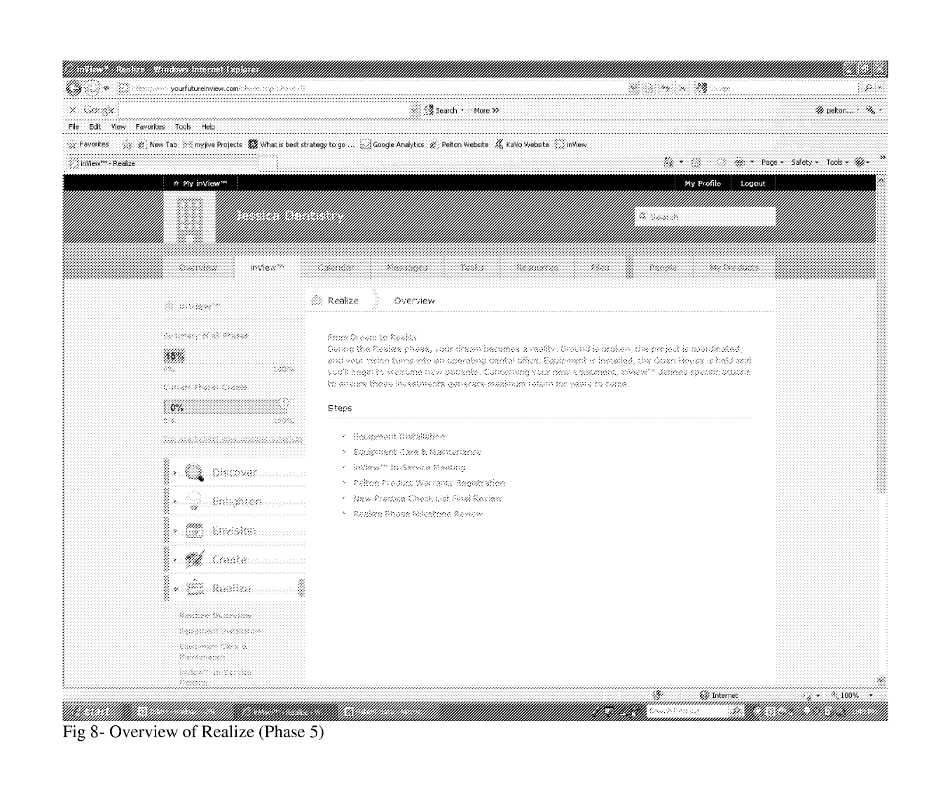

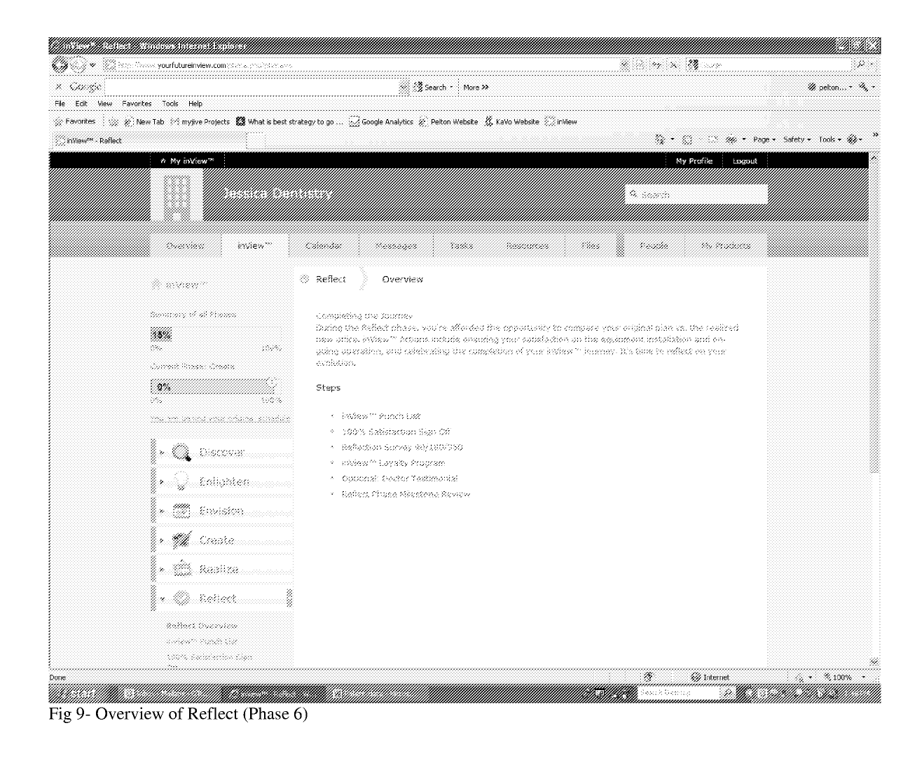

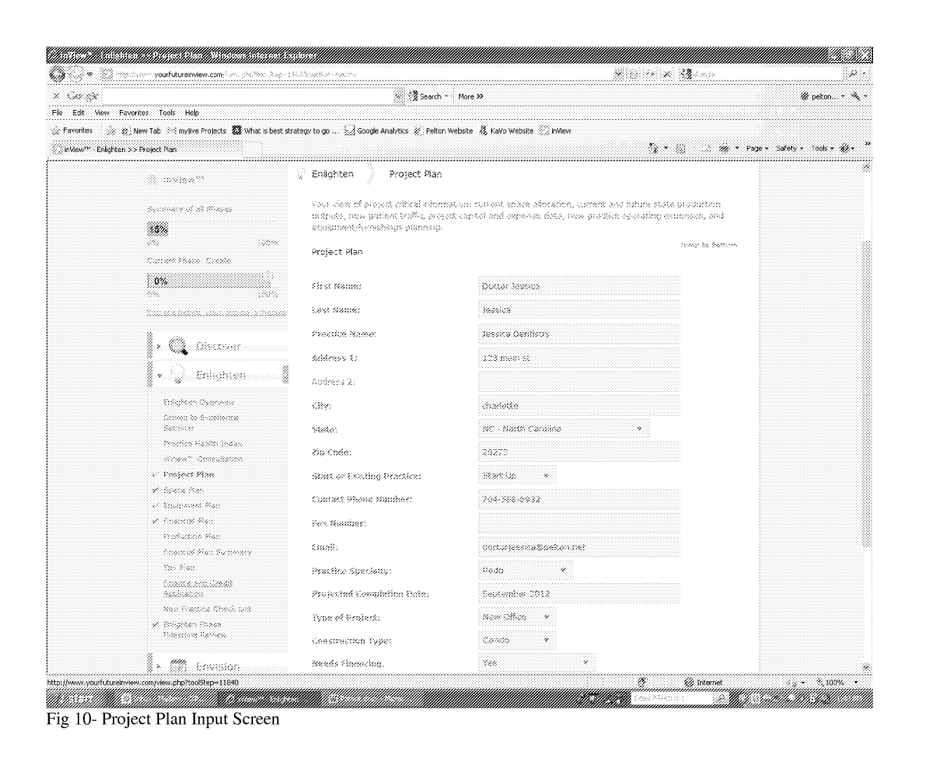

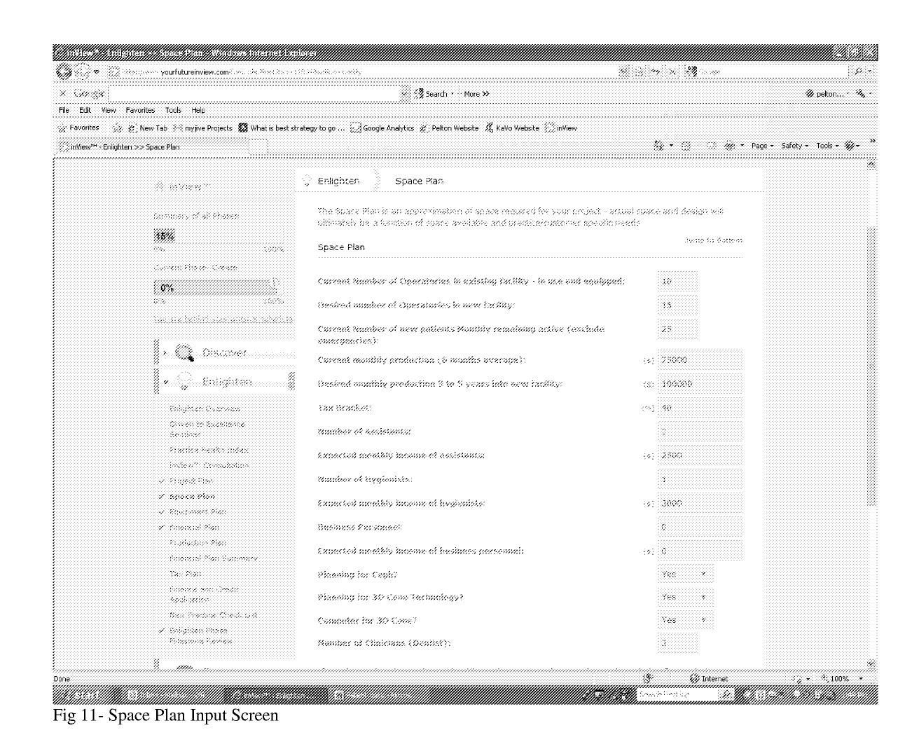

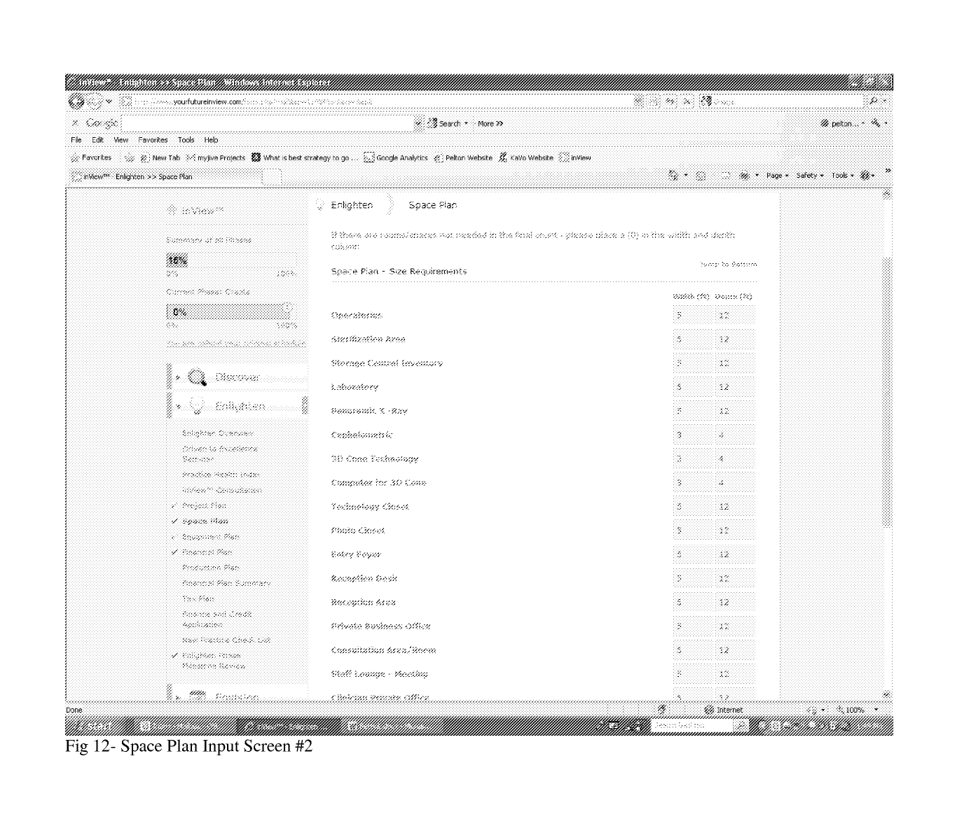

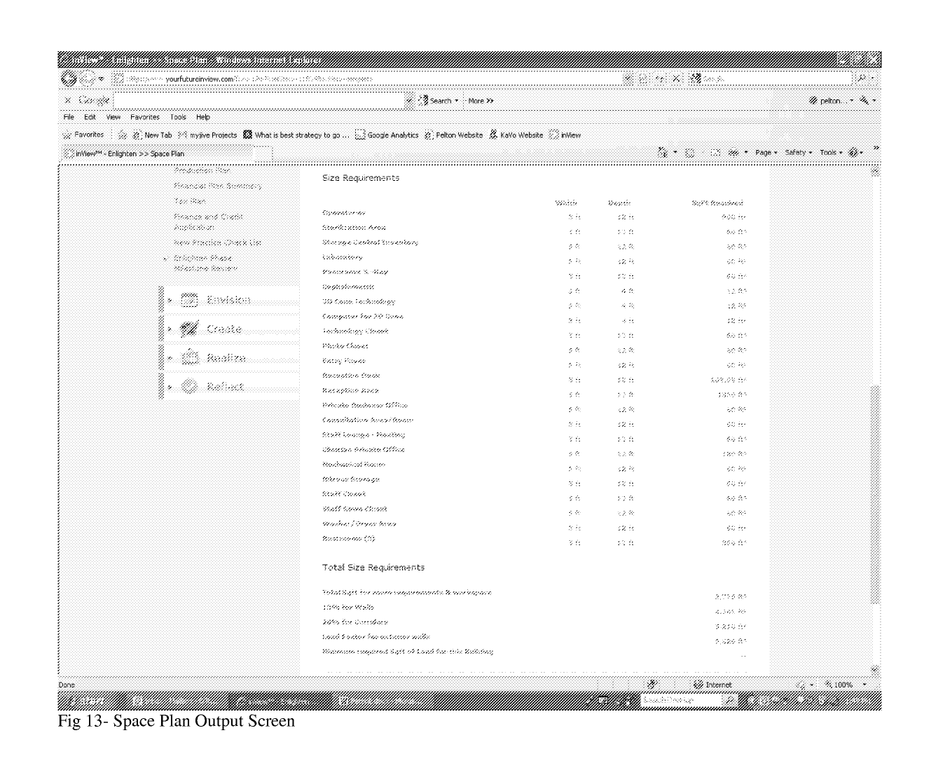

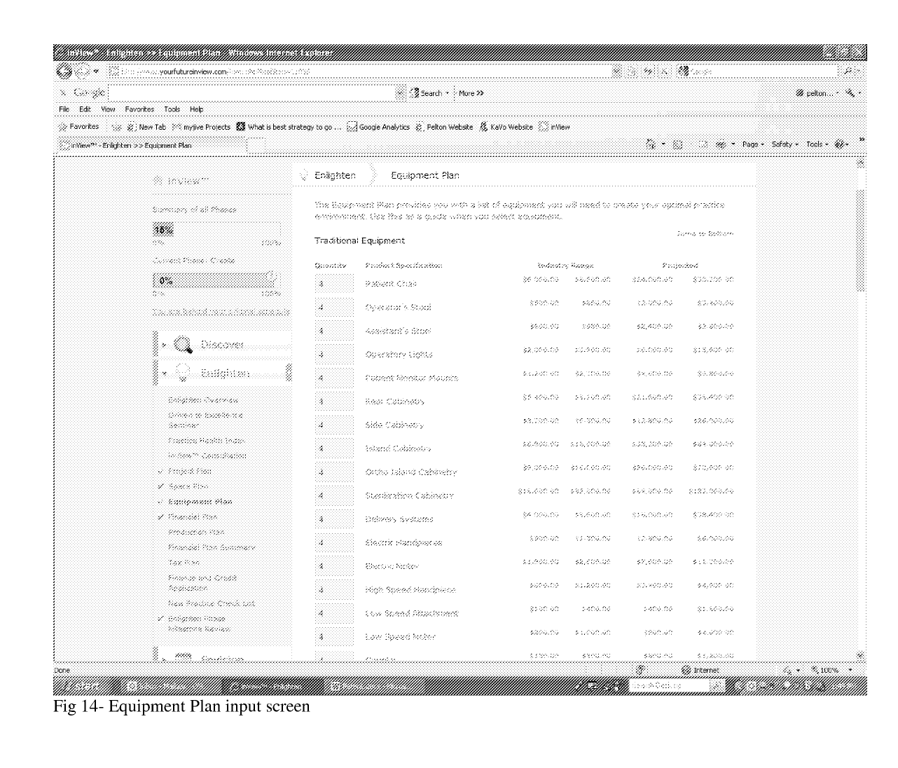

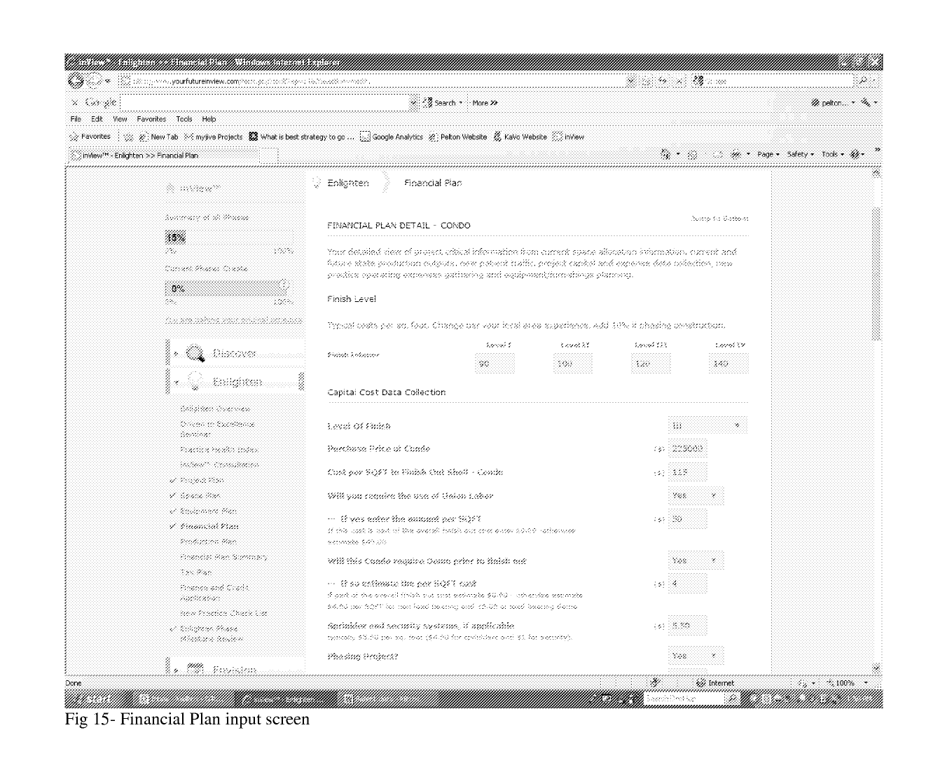

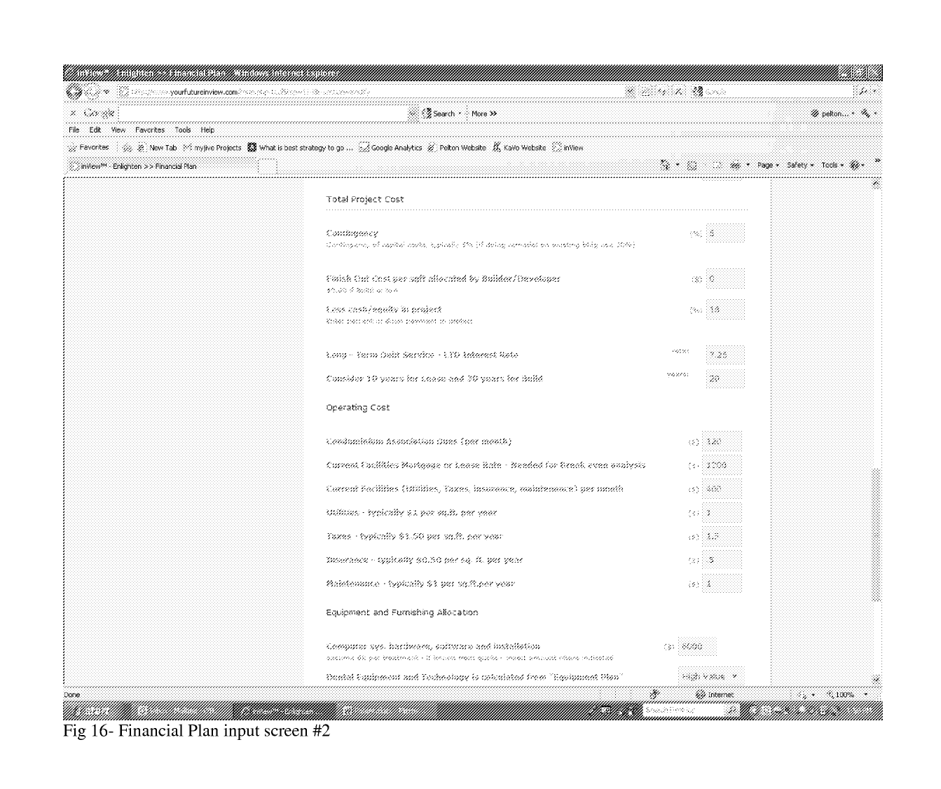

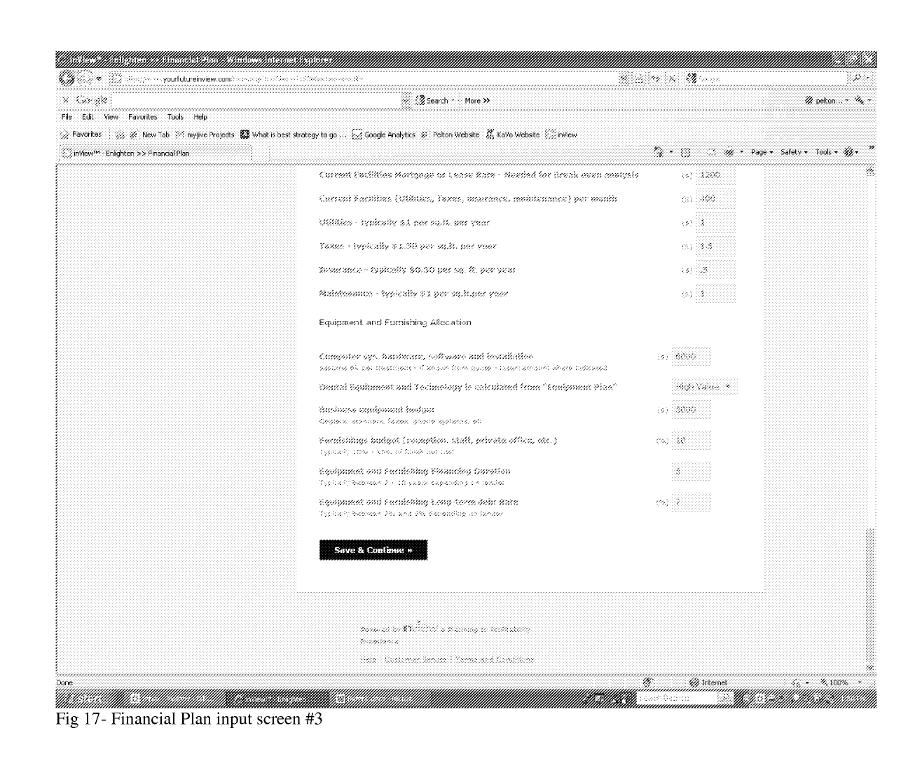

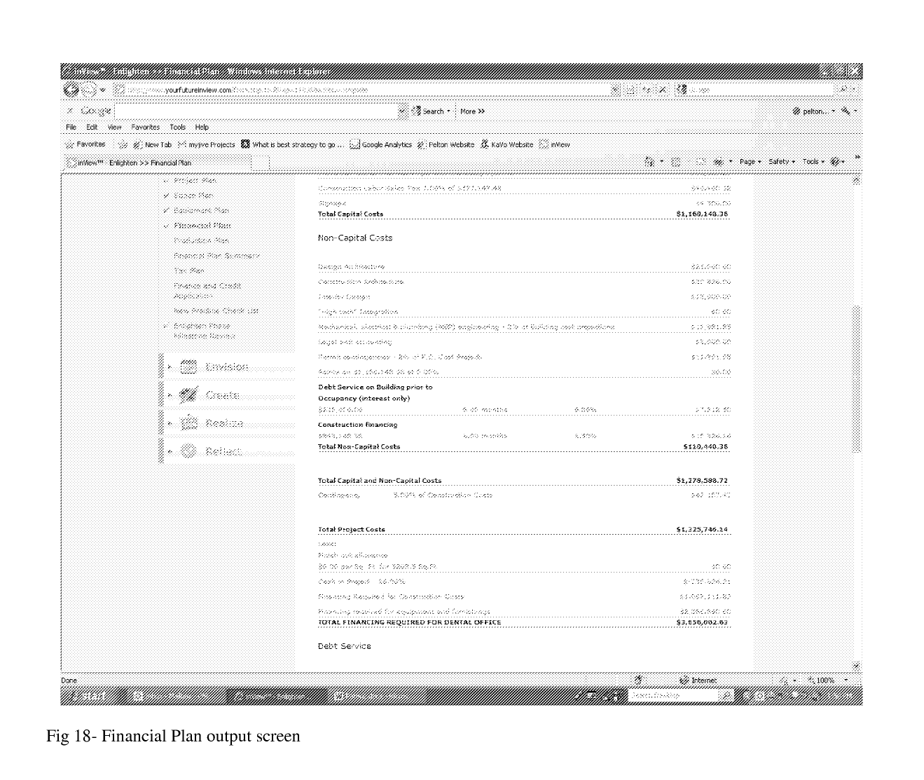

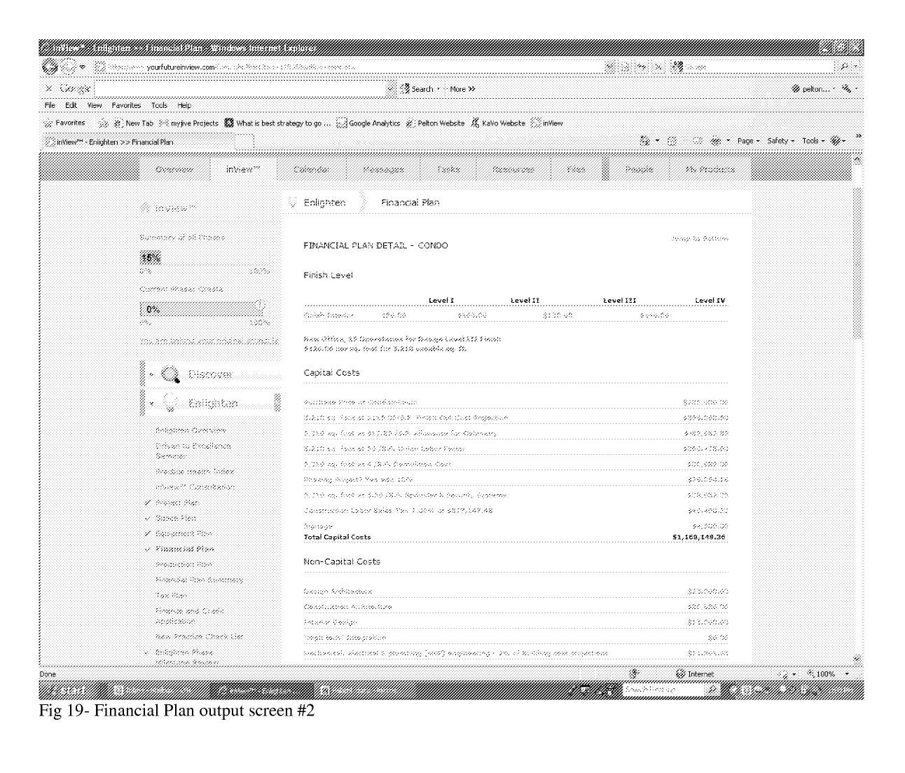

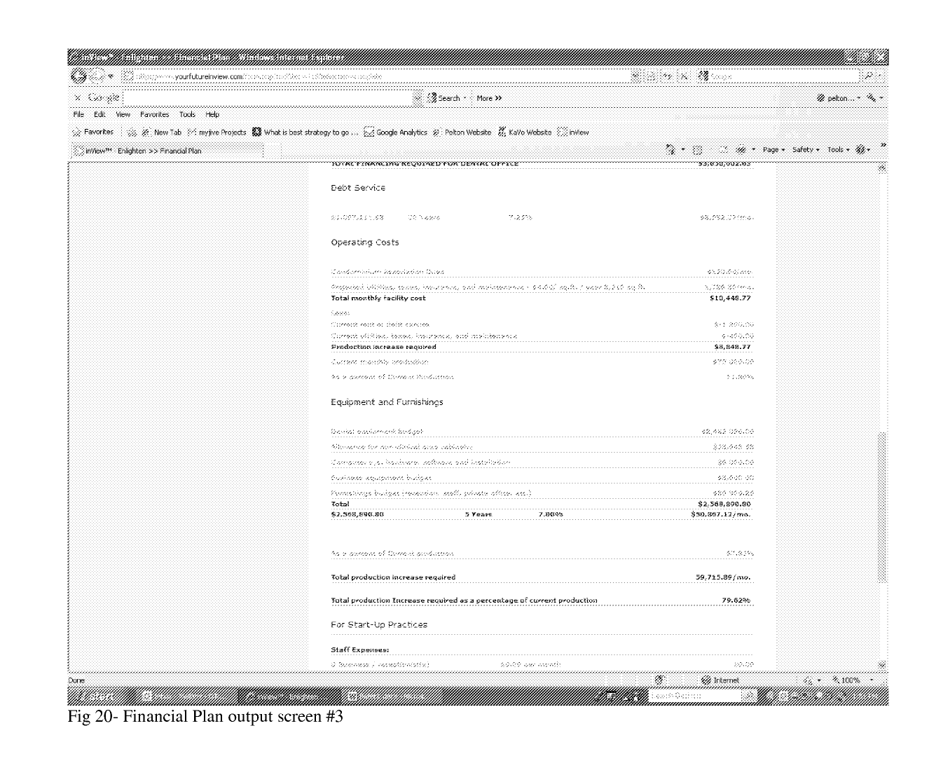

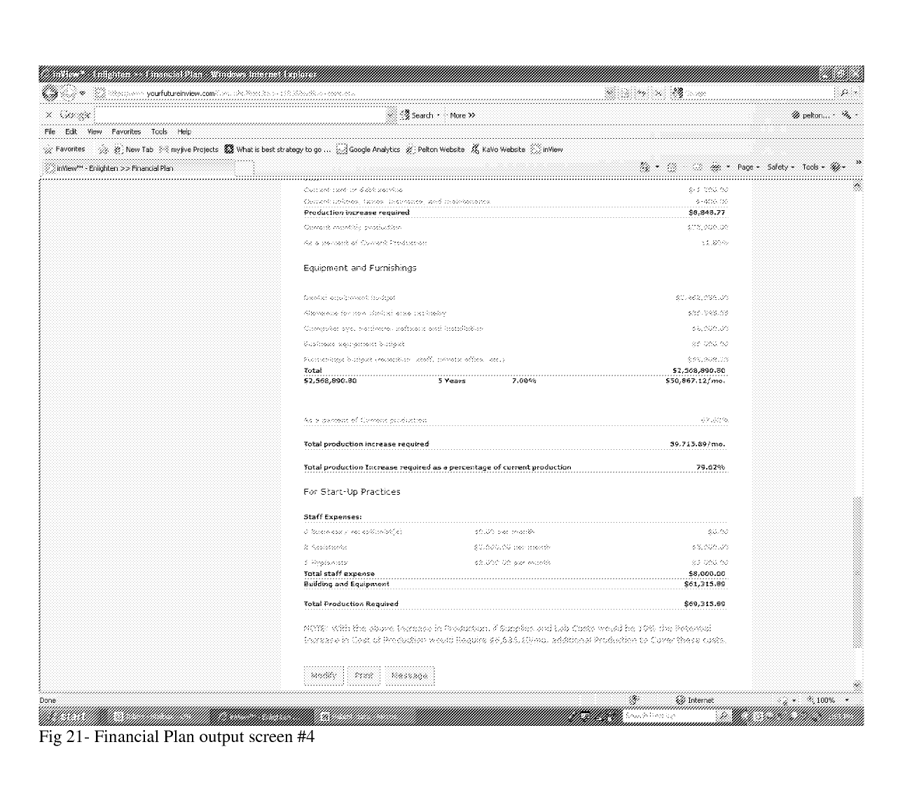

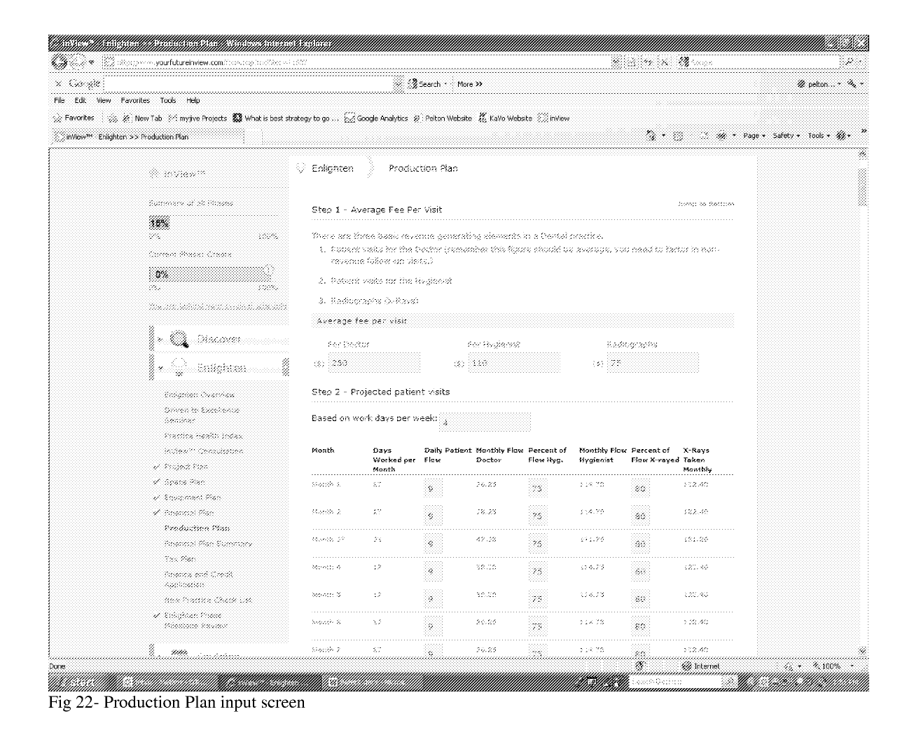

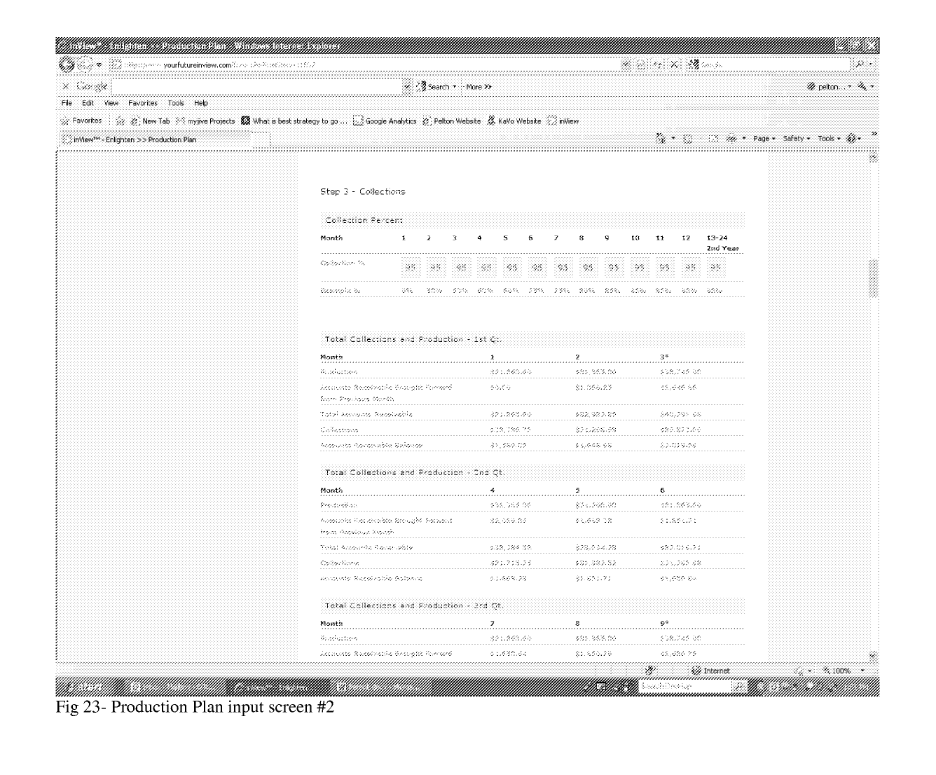

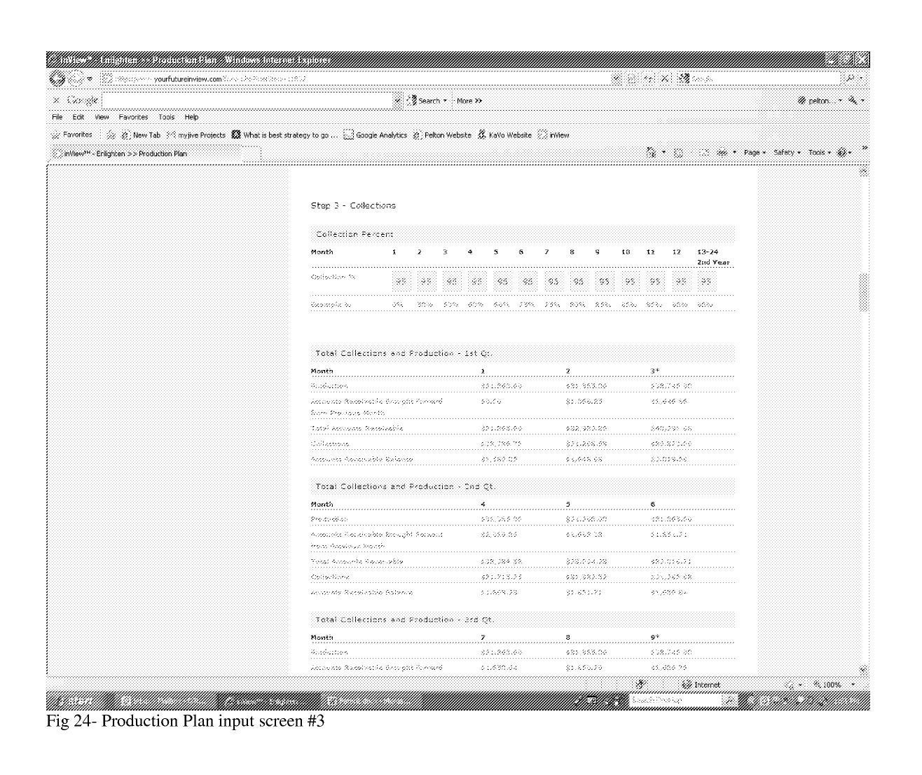

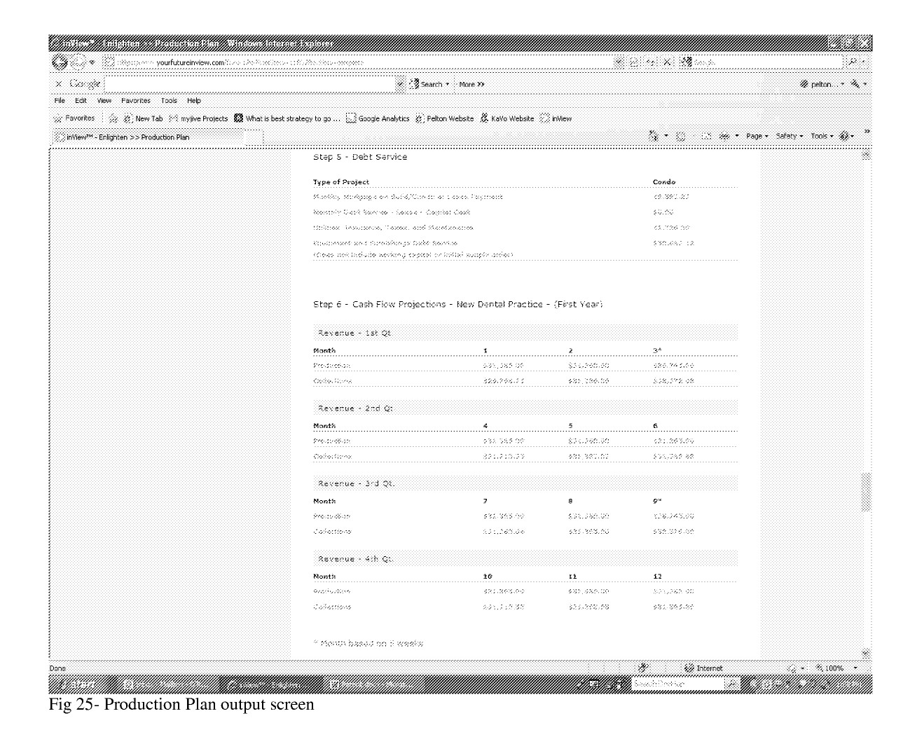

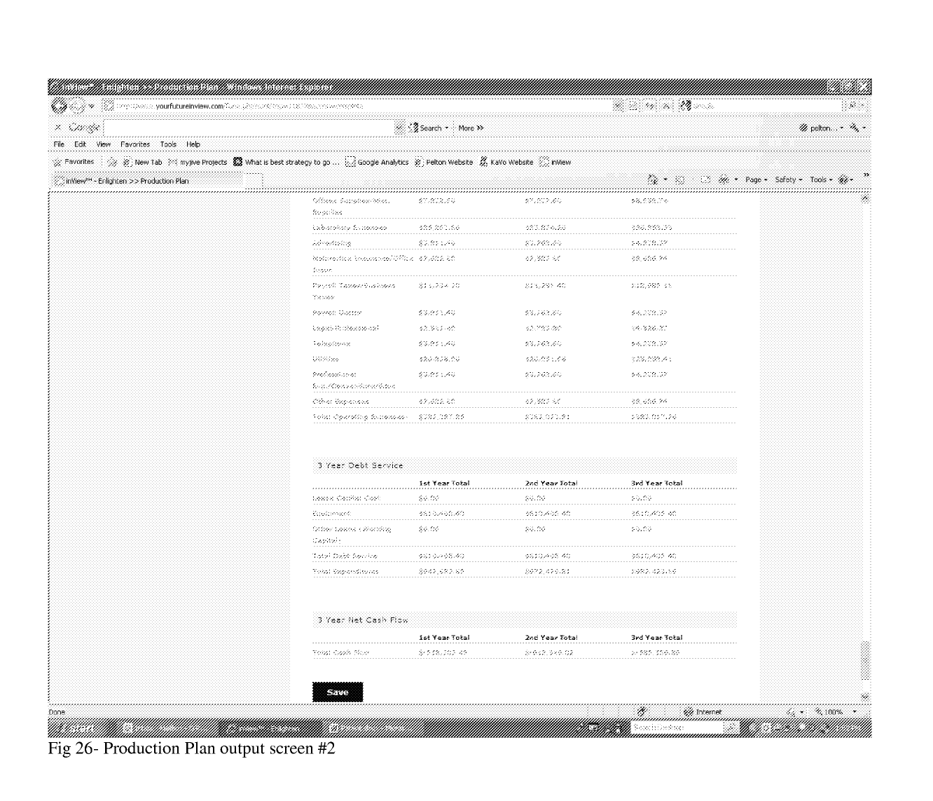

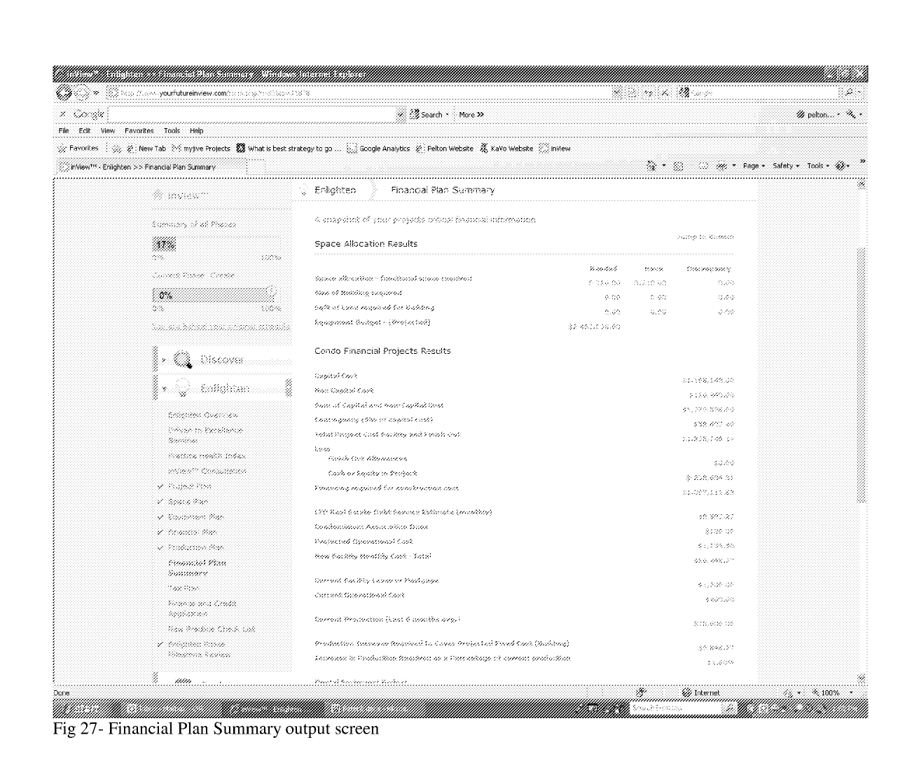

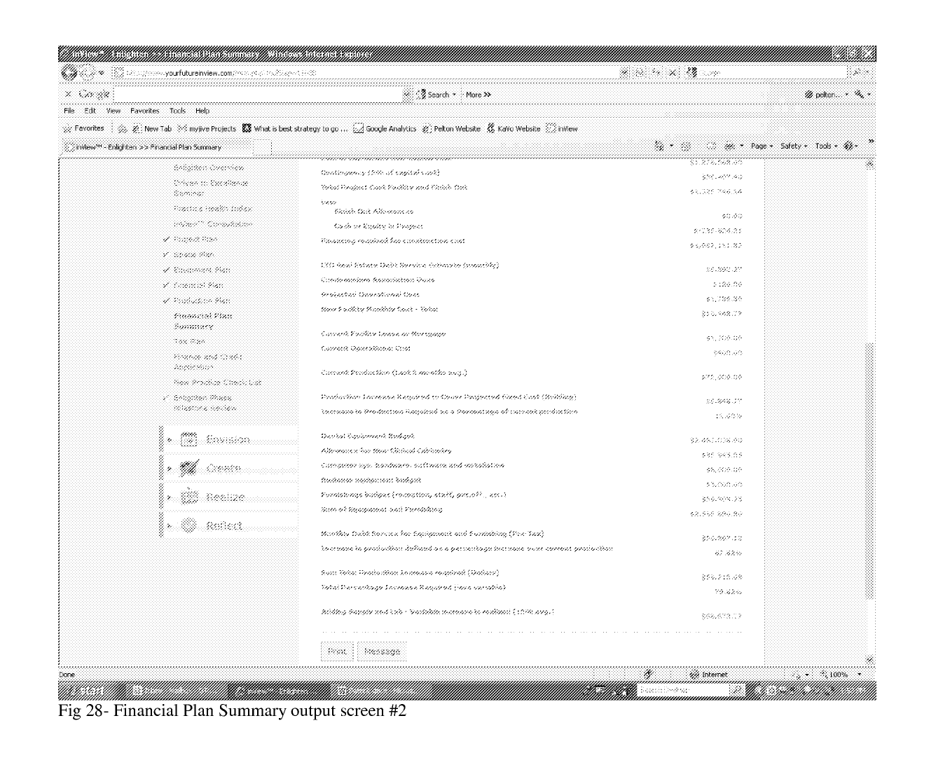

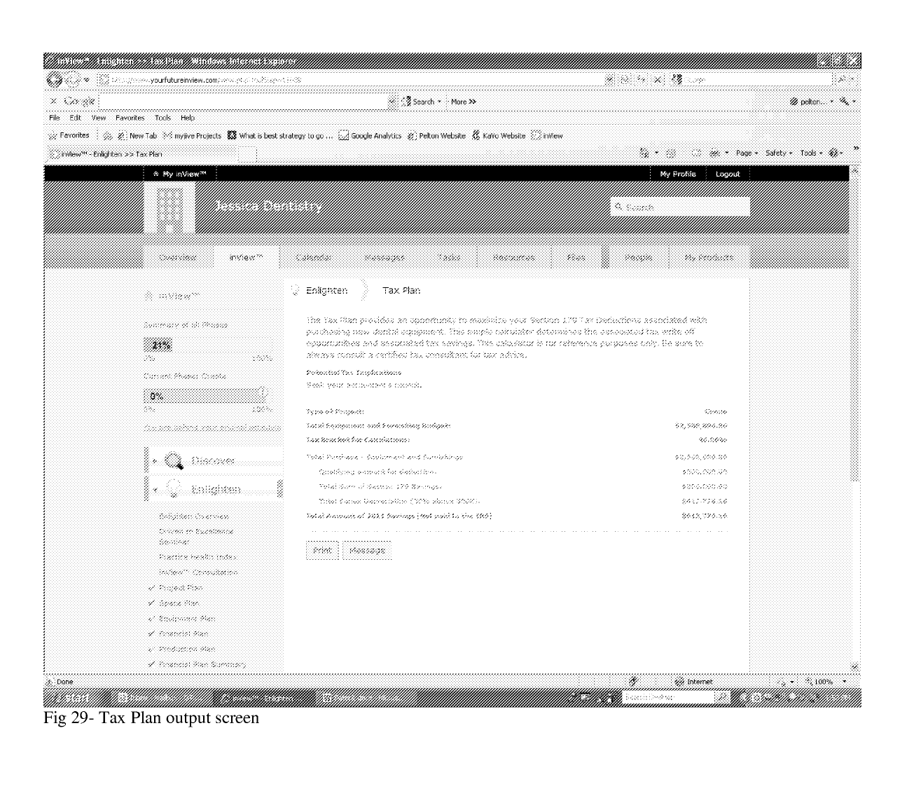

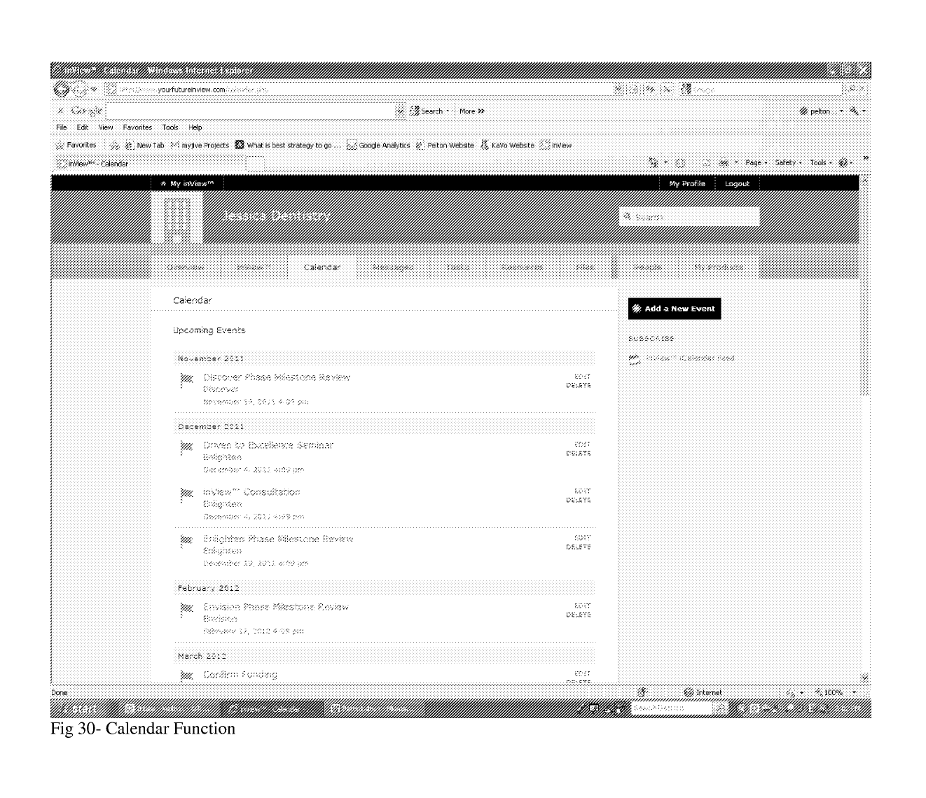

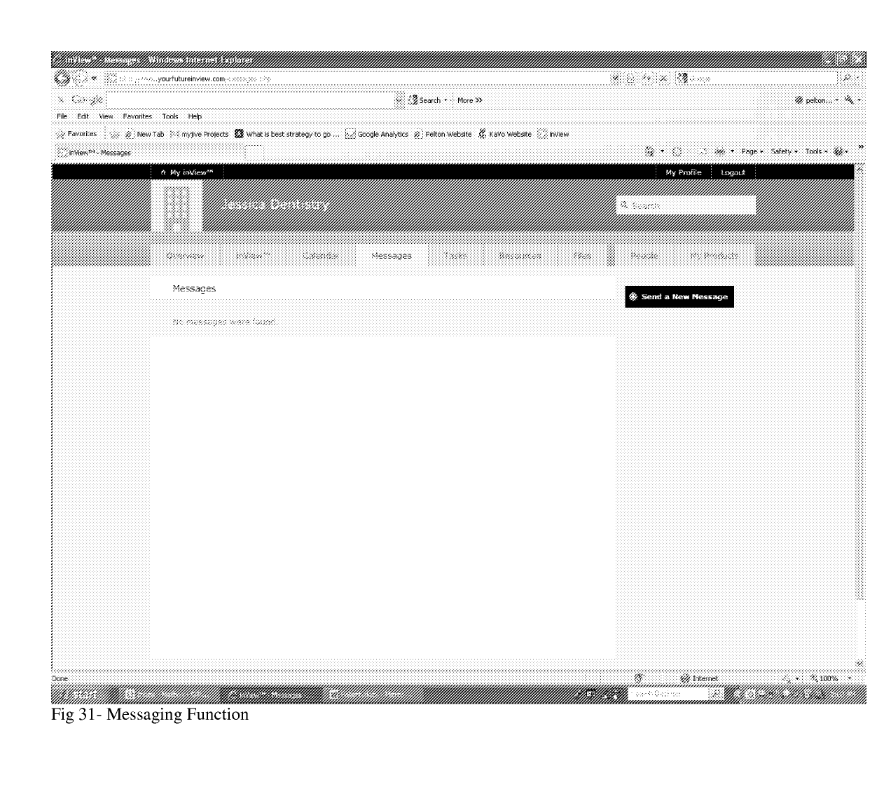

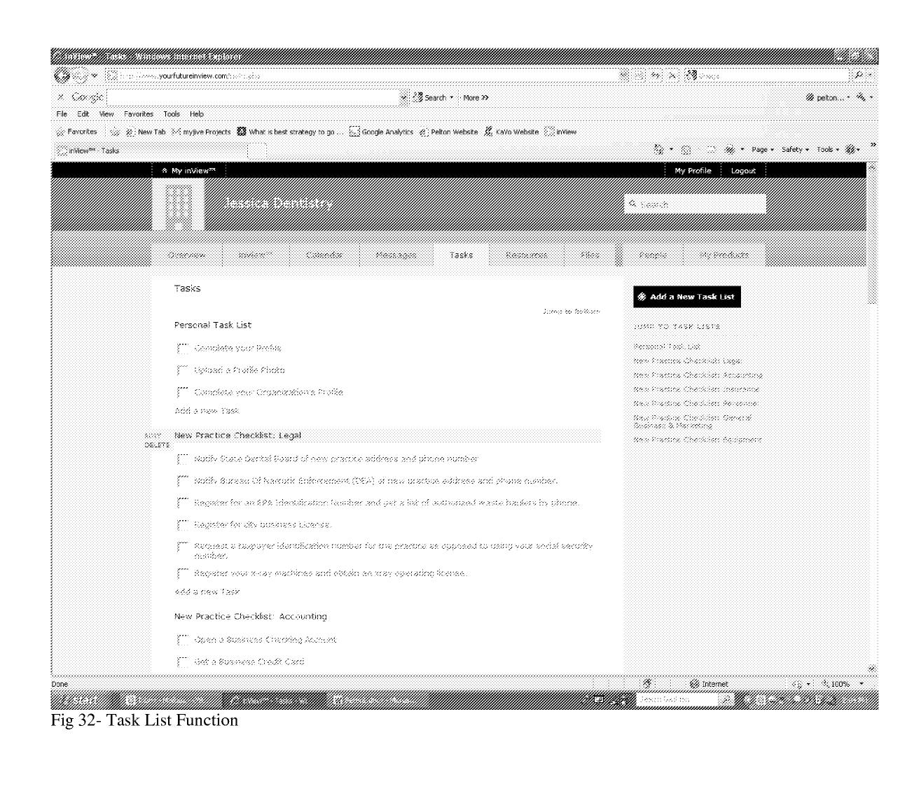

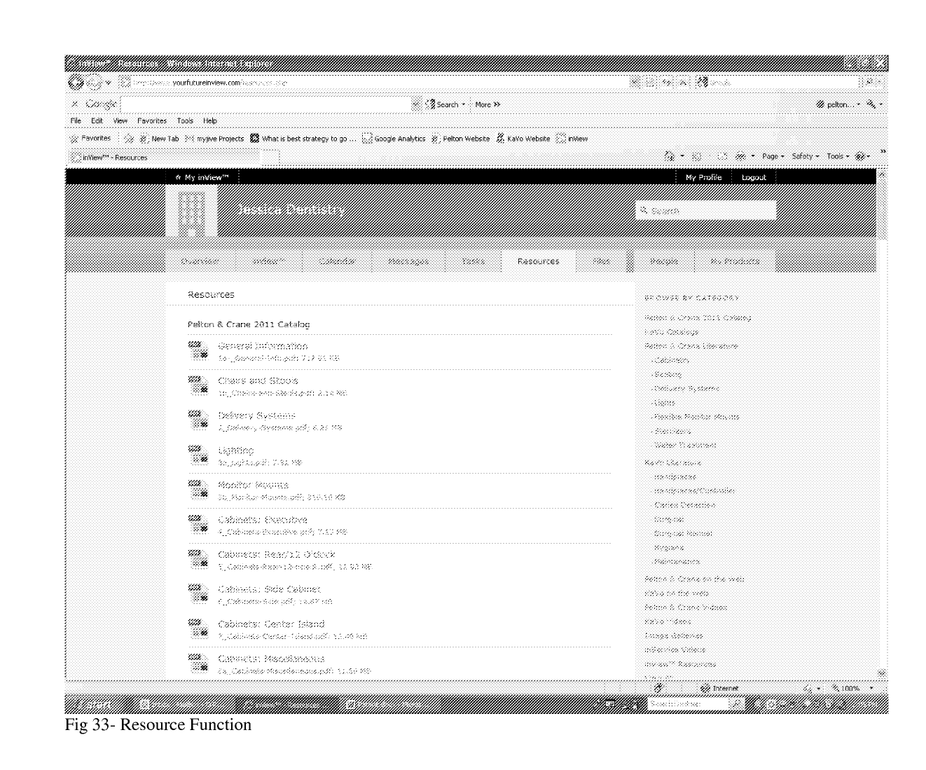

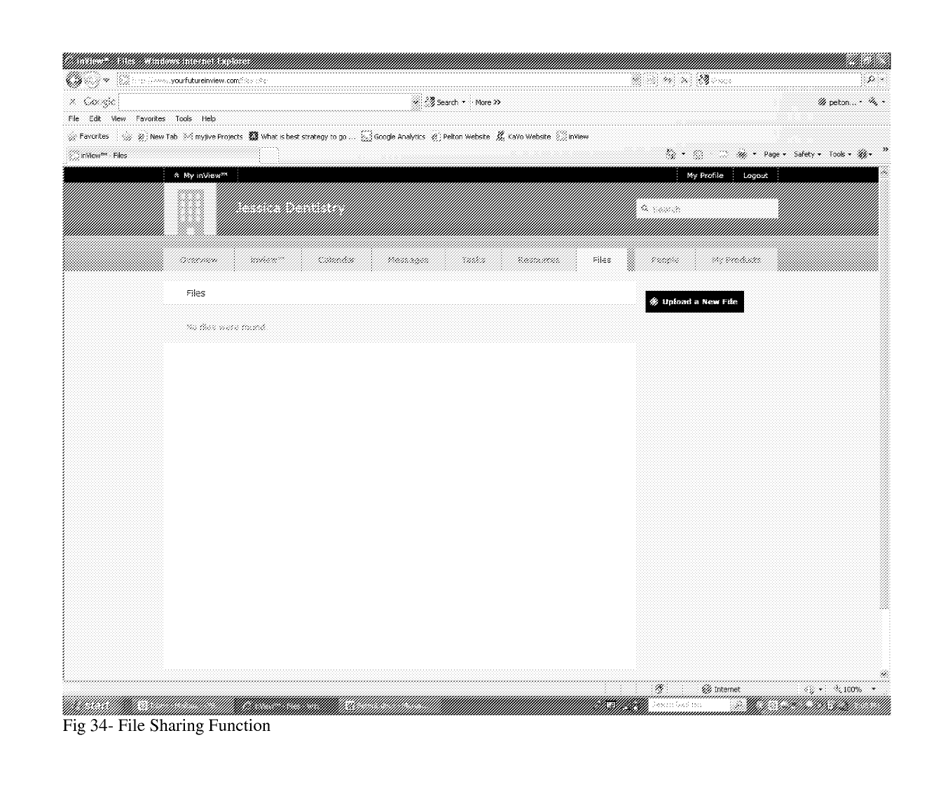

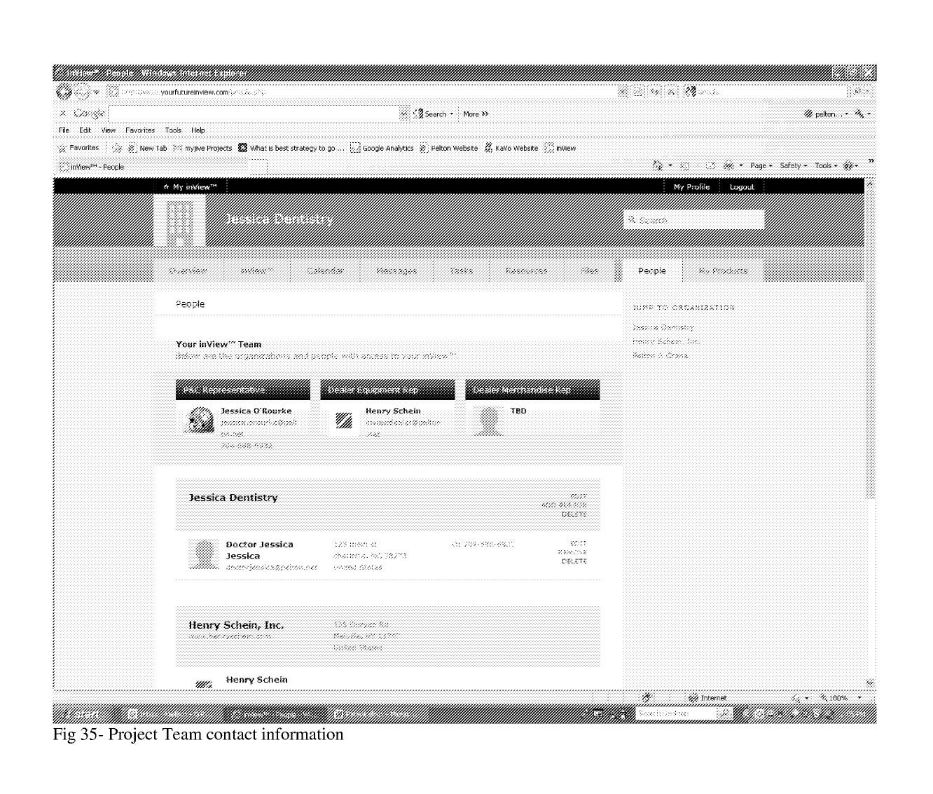

FIG. 2A is a more detailed diagram of a computer system 200, which may be client 106 or server 102. The computer system 200 includes a processor 202 and a memory 204 coupled to the processor 202 through a bus 206. The processor 202 retrieves computer instructions from memory 204 and executes those instructions. The processor 202 also (1) reads data from and writes data to memory 204, (2) sends data and control signals through bus 206 to one or more computer output devices 220, (3) receives data and control signals through bus 206 from one or more computer input devices 230 in accordance with the computer instructions, and (4) transmits and receives data through bus 206 and router 225 to network 104.

Memory 204 can include any type of computer memory including, without limitation, random access memory (RAM), read-only memory (ROM), and storage devices that include storage media such as magnetic and/or optical disks. Memory 204 includes a computer process 210, such as a web browser or web server software. A computer process includes a collection of computer instructions and data that collectively defines a task performed by the computer system 200.

Computer output devices 220 can include any type of computer output device, such as a printer 224, a cathode ray tube (CRT) 222 (alternatively called a monitor or display), a light-emitting diode (LED) display, or a liquid crystal display (LCD). CRT display 222 preferably displays the graphical and textual information of the web browser. Each of the computer output devices 220 receives from the processor 202 control signals and data and, in response to such control signals, displays the received data.

User input devices 230 can include any type of user input device such as a keyboard 232, or keypad, or a pointing device, such as an electronic mouse 234, a trackball, a lightpen, a touch-sensitive pad, a digitizing tablet, thumb wheels, or a joystick. Each of the user input devices 230 generates signals in response to physical manipulation by a user and transmits those signals through the bus 206 to the processor 202.

As previously discussed, to view a web page on client 106, the user specifies, via a URL, the location of the desired web page. The browser on client 106 then retrieves the HTML file for the specified web page, interprets the file, and displays it as a web page.

An implementation of the present invention includes a client/server architecture for HTML documents. The architecture preferably comprises at least two networked computer processors (client component and server component(s)) and a database(s). The computer processors can be processors that are typically found in personal desktop computers (e.g., IBM, Dell, Macintosh), portable computers, mainframes, minicomputers, Unix systems, or other computing devices. Preferably in the networked client/server architecture of the present invention, a classic two or three tier client/server model is utilized. Preferably, a database management system, either as part of the Application Server component or as a separate component (RDB machine), provides the interface to the database.

In a preferred database-centric client/server architecture, the client application generally requests data and data-related services from the application server which makes requests to the database (or the database server). The server(s) (e.g., either as part of the application server machine or a separate database machine) responds to the client's requests and provides access to data. Basic interaction between a client and server is known in the art. In a preferred embodiment of the present invention, a user at a client computer submits a request to the server for a specified action (e.g., access reports). The server receives the request and passes it on to a software program, preferably a CGI (Common Gateway Interface) program that resides in the server computer and processes data submitted from a client. The CGI program processes the data related to the request and dynamically generates a new HTML document and returns it to the server. The server sends the new HTML document to the client. The client then displays the HTML document for the user by using a browser program. Other requests may be processed or the process may terminate.

More specifically, the client components are preferably complete, stand-alone, personal computers offering a full range of power and features to run applications. The client component preferably operates under any operating system and includes communication means, input means, storage means, and display means. The user enters input commands into the computer processor through input means which could comprise a keyboard, mouse, or both. Alternatively, the input means could comprise any device used to transfer information or commands. The display comprises a computer monitor, television, LCD, LED, or any other means to convey information to the user. In a preferred embodiment, the user interface is a web portal comprising graphical user interface (GUI) written for web browser applications.

The server component(s) can be a personal computer, a minicomputer, or a mainframe and offer data management (information sharing between clients), network administration, and security. The Database Server (e.g., RDBMS—Relational Database Management System) and the Application Server may be the same machine or different hosts if desired.

The present invention also envisions other computing arrangements for the client and server(s), including processing on a single machine such as a mainframe, a collection of machines, cloud computing, or other suitable means. The client and server machines work together to accomplish the processing of the present invention.

The database is preferably connected to the database server component and can be any device which will hold data. For example, the database can consist of any type of magnetic or optical storing device for a computer (e.g., CDROM, internal hard drive, tape drive). The database can be located remote to the server component (with access via modem or leased line) or locally to the server component.

In a preferred embodiment, the present invention operates similar to standard interactive web sites with the exception of having the additional unique features of the invention. Preferably, the invention is operated as an interactive web portal (e.g., developed in PHP) with a home page/dashboard and multiple sub-pages linked thereto to provide the different features of the invention. The typical operation of the portal from a user's point of view will now be explained in detail with reference to FIGS. 1-35 which represent the various pages of the Site.

In general, information is collected from the user interactively. This data is analyzed in conjunction with design and project management protocols and tools. The system may utilize various algorithms, real-time learning and inference technology, profiling, pattern recognition learning algorithms, neural networks, and the like in order to lead the user through the process. After the system of the present invention analyzes the data, the next step in the process is to generate, preferably in real-time when available, the necessary reports and outputs for the office design.

The web portal preferably comprises a series of tabs for accessing pages of the site, including Overview, Phases (inView™), Calendar, Messages, Tasks, Resources, Files, People, and My Product. A completion bar graph is included to monitor the percent completion of all phases and of the current phase. A status indicator message is also provided to inform the user if the project is on schedule or behind schedule. The portal landing page comprises a dashboard page, highlighting the 6 phases of the process, a welcome message, last activities, upcoming priorities, upcoming actions and recent actions completed. It includes links to click to other pages on the site, such as a messages page, tasks page, calendar planning tool and resources tab. It also comprises an area for post-sales warranty registration, marketing tool downloads and contacts. The 6 phases comprise the actual project management tools (e.g., discovery questionnaire, financial projection tools, In-Service documents, etc., housed within the portal). The users (e.g., representatives, dealers and doctors) access the portal to review the next steps within each phase, download and utilize tools to support the process through the Phase gate and have the ability to document all elements of the project. The portal is adapted to house videos, marketing literature, multiple project tools, area for warranty registration/product portfolio management, post-sales service tips, marketing tools, etc. Each phase has standard work, or well defined process steps, for all parties to execute. Thus, the system is more than a web portal. It is a well defined tool to methodically lead a doctor through the office design/modernization process.

The six phases are generally described as a discovery phase adapted to initiate and define the design project, an enlighten phase adapted to educate the user in aspects of the design project, an envision phase adapted to provide resources for selecting details of the design project, a create phase adapted to finalize the design project, a realize phase adapted to coordinate and implement the design project, and a reflect phase adapted to conclude the design project. Specific examples of the phases include the following:

Phase 1: Discover—Instigate the Selling Cycle, EBDM/DPAT (HSD), FSC Co-Travel, Pre-sell DTE; or alternatively Discovery Meeting, in View Introduction, Driven to Excellence Registration, Introduction to DPAT.

Phase 2: Enlighten—DTE Pre-work (Discovery Meeting, DPAT (HSD), Pre-DTE Prep); DTE (Consultation, HSD Design, HSD Financial, and HSD Experience); Post-DTE Gift; or alternatively Driven to Excellence Seminar, Practice Health Index, Consultation, Project Plan, Space Plan, Equipment Plan, Financial Plan, Production Plan, Financial Plan Summary, Tax Plan, Finance and Credit Application, New Practice Checklist.

Phase 3: Envision—Acceleration Tool, Portal Experience, Project Tools, Financial, Design/Build, Project Planning, Building promoters before we sell; or alternatively Architect and Contractor Interview, Architect and Contractor Site Assessment and Bid, Architect and Contractor Selection, Final Equipment Plan, Final Production Plan, Final Financial Plan, Final Tax Plan, New Practice Checklist Review.

Phase 4: Create—VIP Experience, Product Selection, HSD Showroom, and Final Funding (HSFS); or alternatively Project and Site Coordination, Confirm Funding, VIP Trip, Final Product Selection, Marketing Plan, New Practice Checklist Review.

Phase 5: Realize—Install, In-Service, Standard Process, Warranty Registration, E-Tools on Portal, and Intro of 100% Satisfaction Program; or alternatively Equipment Installation, Equipment Care & Maintenance, In-Service Meeting, Product Warranty Registration, New Practice Checklist Final Review.

Phase 6: Reflect—100% Satisfaction, 90 day punch list, “Sign off” via Portal, “Office” award, marketing templates; or alternatively Punch List, 100% Satisfaction Sign-Off, Reflection Survey, Loyalty Program, Optional Doctor Testimonial.

Generally, interaction with the system comprises the following steps: (1) User accesses the portal, (2) User registers for an account, (3) system sends user an email confirmation that includes a welcome message, (4) User logs in, such as by using email and password obtained during registration (FIG. 1), (5) system authenticates user and customizes dashboard and populates relevant profile and project plan input fields with the data collected during registration (FIG. 2), (6) User accesses the Phases (inView™) tab to begin their project and complete action items (FIG. 3), (7) User chooses an action item to complete within their current phase, (8) system marks read-only action items as complete when they are opened by user, (9) system marks action items that required a form completion as being complete when information is saved and submitted by the user, (10) system measures project completion and phase completion in a progress bar format based that is visible on both the Project and Overview tabs (see FIGS. 2 and 3) based on how many action items are required and how many have been completed.

One unique feature of the system is the financial analysis which uses the inputs from the user, and then ultimately outputs the value of the project for the dentist (FIG. 27-28). Calculating design data for the design project as part of the financial analysis includes, for example, receiving user inputs and calculating therefrom one or more of: a project plan for required space and land calculations; a space plan for the number of square feet for the project; an equipment plan for estimating a range of prices for desired equipment; a financial plan comprising a total cost for each of the project, space, and equipment plans; and a production plan comprising final cash flow projections and financial analysis.

The Project Plan (FIG. 10) sets the ground work for the financial analysis. The user is asked to input 3 main criteria: The first input selection is: existing vs. start-up practice. If it is a start-up practice, the system will request a set of inputs which will ultimately result in a 3 year cash flow projection. If an existing practice, the system will require an adapted set of inputs, which will result in a break even analysis. The second input selection is: the practice specialty. The dentist will input whether they are a pediatric, general practice, orthodontist or other dentist. Depending on the selection, the lot factor that determines the square feet required for their space, and the estimated supplies and lab costs will increase or decrease as required. The third input selection is: type of project. The dentist will input whether the project involves a build, lease or condo. Depending on the selection, the required space and land calculations, the cost per SQFT to Develop Shell, Topo/soil tests/environmental assessment cost will be affected.

The Space Plan (FIGS. 11-13) calculates the required number of square feet for the project. The user inputs the current and the desired number of operatories, current number of patients, current production, desired production, tax brackets, number of personnel and salary by type, whether they will be integrating specific new technology offerings, and number of dentists. The user also inputs the size requirements for the new office by inputting the width and depth of each room included in their desired dental office.

The computer multiplies the desired number of operatories by the desired width/depth of the operatory. The computer calculates the size requirement of the reception area based on the number of dentists and the number of patients. The computer calculates a suggested number of restrooms based on the number of operatories desired and uses the width/depth inputs for the bathroom, multiplied by the suggested number of restrooms to determine a required square feet for restrooms. The computer than aggregates all of the size requirements to determine the final square feet required for the project.

The Equipment Plan (FIG. 14) provides an industry range of prices for the various instruments and equipment a dentist will need for their practice. The user selects the quantity they would like of each item, and the system multiplies this number by the industry range and ultimately provides a low, mid and high estimate for the desired equipment. During the Financial Plan, the user will input their selection which reflects the quality level of equipment they will purchase.

The Financial Plan (FIGS. 15-21) requires inputs relating to finish level costs, capital costs, non-capital costs, land value, debt service, operating cost, and equipment cost. The output includes a total cost for each of these areas. If the project chosen was a start-up, the final output of the financial plan is the total monthly production required to sustain the project. If the project was an existing practice, the final output of the financial plan is the total production increased required to sustain the project.

The Production Plan (FIGS. 22-26) inputs are based on the user's selection during the initial Project Plan. If the selection inputted was Start Up, the user will input the desired number of days worked per week, the number of patients seen per day by dentist, hygienist, the percentage of patients that receive x-rays, the average fees per visit broken down by dentist, hygienist, and x-ray, and the monthly collection percentages. These numbers are then aggregated by the computer to determine the net income of the new practice. The computer compiles the financial costs associated with the project as determined in the financial plan, and creates the final cash flow projections and financial break even analysis.

The Tax Plan (FIG. 29) uses the input from the user of their tax bracket and the output of the final equipment selection value, and ultimately outputs the amount of section 179 savings a dentist will obtain based on their selected level of equipment.

The Calendar function is illustrated in FIG. 30 showing upcoming events and dates. Events can be added, edited, and deleted in the Calendar. A messaging function (FIG. 31) is also provided where messages can be sent and received and are listed. FIG. 32 illustrates a Task List function where tasks are listed and can be checked off as completed. Multiple task list categories can be provided. FIG. 33 illustrates a Resource function where resources are stored and accessible. FIG. 34 shows a file sharing function to allow upload and sharing of files for the project. FIG. 35 illustrates a contact page for team contact information.

It will be readily appreciated that the principles of the invention may apply to other computer applications, such as other mainframes, minicomputers, network servers, supercomputers, personal computers, or workstations, as well as other electronics applications. Therefore, while the discussion herein focuses on a particular application, it should be understood that the invention is not limited to the particular hardware designs, software designs, communications protocols, performance parameters, or application-specific functions disclosed herein.

The invention can also be embodied as computer readable code on a tangible computer readable medium. The computer readable medium is any data storage device that can store data which thereafter can be read by a computer system. Examples of computer readable medium include read-only memory, random-access memory, CD-ROMs, magnetic tape, optical data storage devices.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for example, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention as set forth in the claims.

One skilled in the art of computer science will easily be able to combine the software created as described with appropriate general purpose or special purpose computer hardware to create a computer system or computer sub-system embodying the method of the invention.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

It should be understood that the examples and embodiments described herein are for illustrative purposes only and that various modifications or changes in light thereof will be suggested to persons skilled in the art and are to be included within the spirit and purview of this application.

1. A computer-implemented method for managing a project, comprising:
(a) providing a project management tool for designing a medical practice, wherein the tool is adapted to guide a user through at least partial completion of a design project through a series of phases, each phase comprising one or more predetermined action items for the design project, wherein the project management tool, when executed by a processor, generates a graphical user interface adapted to allow progression through each phase in the series of phases by:
(i) displaying a current phase and the one or more action items to be completed for the current phase;
(ii) receiving input from the user for each of the one or more action items;
(iii) monitoring completion of each of the one or more action items;
(iv) upon completion of the one or more action items in the current phase, proceeding to a next phase in the series of phases;
(b) calculating from the input received design data for the design project;
(c) outputting a report comprising the calculated design data for the design project.

2. The computer-implemented method of claim 1, wherein the project management tool is implemented on a server computer as an interactive web portal accessible to a remote client computer via a communications network.

3. The computer-implemented method of claim 1, further comprising providing third-party access to the project management tool upon receiving input by the user that authorizes third-party access.

4. The computer-implemented method of claim 1, further comprising automated or user generated updating of a status indicator to acknowledge completion of each of the one or more action items.

5. The computer-implemented method of claim 1, further comprising displaying a completion progress indicator that indicates a percent completion of all phases and of the current phase.

6. The computer-implemented method of claim 1, wherein calculating design data for the design project comprises analyzing the design data in conjunction with predetermined design and project management protocols.

7. The computer-implemented method of claim 1, further comprising monitoring a predetermined schedule for the design project and providing a status indicator message regarding whether the design project is on schedule or behind schedule.

8. The computer-implemented method of claim 1, further comprising transmitting the report comprising the calculated design data for the design project to third parties to assist in the coordination and implementation of the design project.

9. The computer-implemented method of claim 1, wherein the one or more phases comprise a discovery phase adapted to initiate and define the design project, an enlighten phase adapted to educate the user in aspects of the design project, an envision phase adapted to provide resources for selecting details of the design project, a create phase adapted to finalize the design project, a realize phase adapted to coordinate and implement the design project, and a reflect phase adapted to conclude the design project.

10. The computer-implemented method of claim 1, wherein calculating design data for the design project comprises financial analysis that includes receiving user inputs and calculating therefrom one or more of: a project plan for required space and land calculations; a space plan for the number of square feet for the project; an equipment plan for estimating a range of prices for desired equipment; a financial plan comprising a total cost for each of the project, space, and equipment plans; and a production plan comprising final cash flow projections and financial analysis.

11. A project management system for designing a medical practice, comprising:
a processor, and memory coupled to the processor, wherein the memory comprises program instructions executable by the processor to implement a project management tool stored in memory, wherein the tool is adapted to guide a user through at least partial completion of a design project through a series of phases, each phase comprising one or more predetermined action items for the design project, wherein the project management tool, when executed by the processor, generates on a display a graphical user interface adapted to allow progression through each phase in the series of phases by:
(i) displaying a current phase and the one or more action items to be completed for the current phase;
(ii) receiving input from the user for each of the one or more action items;
(iii) monitoring completion of each of the one or more action items;
(iv) upon completion of the one or more action items in the current phase, proceeding to a next phase in the series of phases;
wherein the processor is adapted to calculate from the input received design data for the design project and output a report comprising the calculated design data for the design project.

12. The project management system of claim 11, wherein the processor resides on a server computer accessible to a remote client computer via a communications network and is adapted to implement the project management tool as an interactive web portal.

13. The project management system of claim 11, wherein the project management tool is further adapted to provide third-party access to the project management tool upon receiving input by the user that authorizes third-party access.

14. The project management system of claim 11, wherein the project management tool is further adapted to provide automated or user generated updating of a status indicator to acknowledge completion of each of the one or more action items.

15. The project management system of claim 11, wherein the project management tool is further adapted to display a completion progress indicator that indicates a percent completion of all phases and of the current phase.

16. The project management system of claim 11, wherein the project management tool is further adapted to analyze the design data in conjunction with predetermined design and project management protocols as part of the calculating design data for the design project.

17. The project management system of claim 11, wherein the project management tool is further adapted to monitor a predetermined schedule for the design project and provide a status indicator message regarding whether the design project is on schedule or behind schedule.

18. The project management system of claim 11, wherein the project management tool is further adapted to transmit the report comprising the calculated design data for the design project to third parties to assist in the coordination and implementation of the design project.

19. A non-transitory computer-readable medium having stored thereon code devices for implementing a computer-implemented project management method, the code devices comprising a project management tool for designing a medical practice, wherein the tool is adapted to guide a user through at least partial completion of a design project through a series of phases, each phase comprising one or more predetermined action items for the design project, wherein the project management tool, when executed by a processor, generates a graphical user interface adapted to allow progression through each phase in the series of phases by:
(i) displaying a current phase and the one or more action items to be completed for the current phase;
(ii) receiving input from the user for each of the one or more action items;
(iii) monitoring completion of each of the one or more action items;
(iv) upon completion of the one or more action items in the current phase, proceeding to a next phase in the series of phases; and
wherein the project management tool is adapted to calculate from the input received design data for the design project and output a report comprising the calculated design data for the design project.

20. The non-transitory computer-readable medium of claim 19 wherein the project management tool is adapted to be implemented on a server computer as an interactive web portal accessible to a remote client computer via a communications network.
